(19) United States
(12) Patent Application Publication
(10) Pub. No.: US 2025/0317790 A1
(43) Pub. Date: Oct. 9, 2025

(54) RELAY-ASSISTED REMOTE UE POSITIONING REPORTING

(71) Applicant: QUALCOMM Incorporated, San Diego, CA (US)

(72) Inventors: Mukesh KUMAR, Hyderabad (IN); Srinivas YERRAMALLI, San Diego, CA (US); Alexandros MANOLAKOS, Athens (GR)

(21) Appl. No.: 18/872,268

(22) PCT Filed: Jul. 5, 2023
(86) PCT No.: PCT/US2023/026952

§ 371 Date: Dec. 5, 2024

(30) Foreign Application Priority Data
Jul. 18, 2022 (GR) 20220100567

(51) Int. Cl. H04W 28/02; H04W 64/00; H04W 92/18

(52) U.S. Cl. CPC H04W 28/0268; H04W 64/00; H04W 92/18

(57) ABSTRACT

A relay user equipment (UE) may be configured to receive an indication of one or more of at least one first quality of service (QOS) parameter for a first wireless link or at least one second QoS parameter for a second wireless link. The first wireless link may be associated with the relay UE and a network entity. The second wireless link may be associated with the relay UE and at least one remote UE. The at least one first QoS parameter and the at least one second QoS parameter may be associated with a time period. The relay UE may be configured to transmit a report of at least one positioning measurement within the time period based on one or more of the at least one first Qos parameter or the at least one second QoS parameter.

### CROSS-REFERENCE TO RELATED APPLICATION

This application claims the benefit of Greece Patent Application Serial No. 20220100567, entitled “RELAY-ASSISTED REMOTE UE POSITIONING REPORTING” and filed on Jul. 18, 2022, which is expressly incorporated by reference herein in its entirety.

### TECHNICAL FIELD

The present disclosure relates generally to communication systems, and more particularly, to a relay-assisted remote user equipment (UE) positioning system.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may have a memory and at least one processor coupled to the memory at a relay UE. Based at least in part on information stored in the memory, the at least one processor may be configured to receive an indication of one or more of at least one first quality of service (QOS) parameter for a first wireless link or at least one second QoS parameter for a second wireless link. The indication may be received from a network entity. The first wireless link may be associated with the relay UE and the network entity. The second wireless link may be associated with the relay UE and at least one remote UE. The at least one first QoS parameter and the at least one second QoS parameter may be associated with a time period. Based at least in part on information stored in the memory, the at least one processor may be configured to transmit a report of at least one positioning measurement within the time period based on one or more of the at least one first QoS parameter or the at least one second QoS parameter. The report may be transmitted to the network entity.

In an aspect of the disclosure, a method, a computer-readable medium, and an apparatus are provided. The apparatus may have a memory and at least one processor coupled to the memory at a network entity. Based at least in part on information stored in the memory, the at least one processor may be configured to transmit an indication of one or more of at least one first QoS parameter for a first wireless link or at least one second QoS parameter for a second wireless link. The indication may be transmitted to a relay UE. The first wireless link may be associated with the relay UE and the network entity. The second wireless link may be associated with the relay UE and at least one remote UE. The at least one first QoS parameter and the at least one second QoS parameter may be associated with a time period. Based at least in part on information stored in the memory, the at least one processor may be configured to obtain a report of at least one positioning measurement within the time period based on one or more of the at least one first QoS parameter or the at least one second QoS parameter. The report may be obtained from the relay UE.

To the accomplishment of the foregoing and related ends, the one or more aspects include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 are diagrams illustrating example aspects of slot structures that may be used for sidelink communication.

FIG. 5 is a diagram illustrating an example of sidelink communication between devices, in accordance with aspects presented herein.

FIG. 6 is a diagram illustrating an example of a UE positioning based on reference signal measurements.

FIG. 7 is a diagram illustrating an example of a remote UE configured to perform a positioning session through a relay UE.

FIG. 8 is a diagram illustrating another example of a remote UE configured to perform a positioning session through a relay UE.

FIG. 9 is a diagram illustrating another example of a remote UE configured to perform a positioning session through a relay UE.

FIG. 10 is a diagram illustrating another example of a remote UE configured to perform a positioning session through a relay UE.

FIG. 11 is a flowchart of a method of wireless communication.

FIG. 12 is another flowchart of a method of wireless communication.

FIG. 13 is a diagram illustrating an example of a hardware implementation for an example apparatus and/or network entity.

FIG. 14 is a diagram illustrating an example of a hardware implementation for an example network entity.

FIG. 15 is a diagram illustrating an example of a hardware implementation for an example network entity.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer. While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

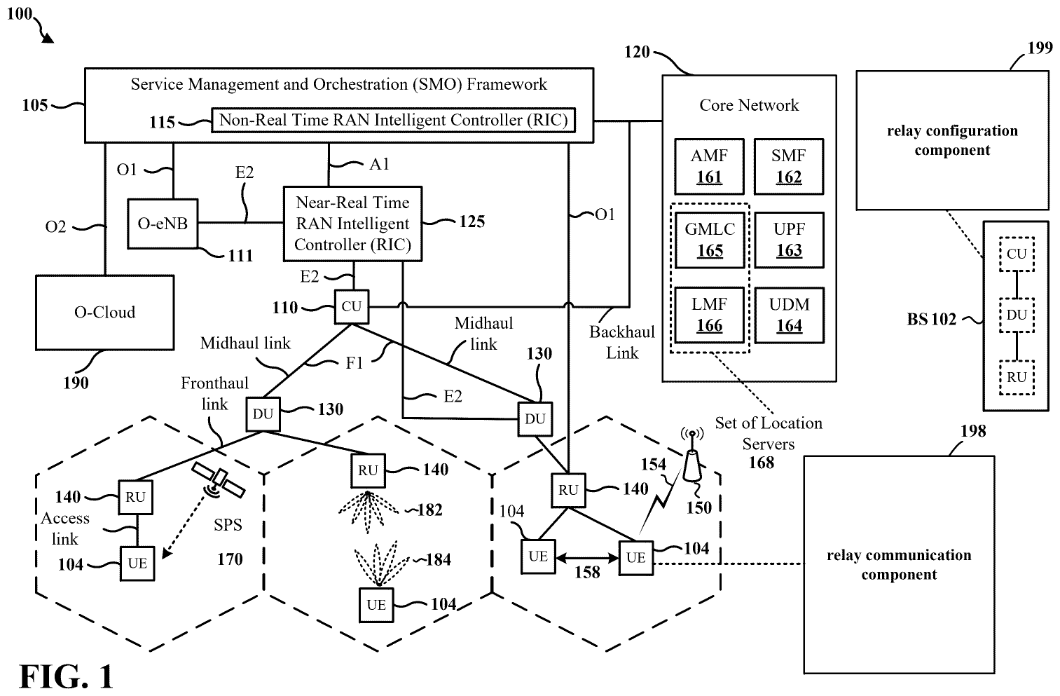

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (eNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell). Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, Location Management Function (LMF), or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a relay communication component 198 configured to receive an indication of one or more of at least one first QoS parameter for a first wireless link or at least one second QoS parameter for a second wireless link. The indication may be received from a network entity, such as the base station 102. The first wireless link may be associated with a relay UE and a network entity. The second wireless link may be associated with a relay UE and at least one remote UE. The at least one first QoS parameter and the at least one second QoS parameter may be associated with a time period. The relay communication component 198 may be configured to transmit a report of at least one positioning measurement within the time period based on one or more of the at least one first QoS parameter or the at least one second QoS parameter. The report may be transmitted to the network entity. In certain aspects, the base station 102 may have a relay configuration component 199 configured to transmit an indication of one or more of at least one first QoS parameter for a first wireless link or at least one second QoS parameter for a second wireless link. The indication may be transmitted to a relay UE. The first wireless link may be associated with a relay UE and a network entity. The second wireless link may be associated with a relay UE and at least one remote UE. The at least one first QoS parameter and the at least one second QoS parameter may be associated with a time period. The relay configuration component 199 may be configured to obtain a report of at least one positioning measurement within the time period based on one or more of the at least one first QoS parameter or the at least one second QoS parameter. The report may be obtained from a relay UE. Although the following description may be focused on sidelink communication, the concepts described herein may be applicable to any D2D communication links. Although the following description may be focused on 5G NR or LTE, the concepts described herein may be applicable to other similar areas, such as LTE-A, CDMA, GSM, and other wireless technologies.

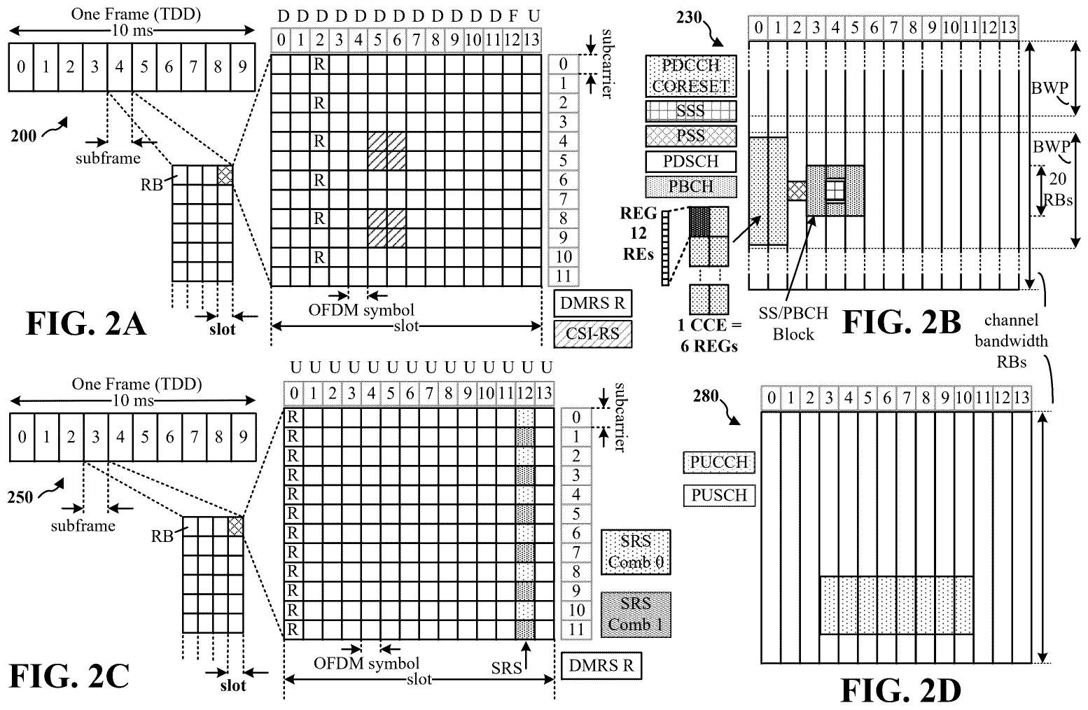

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ*}15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

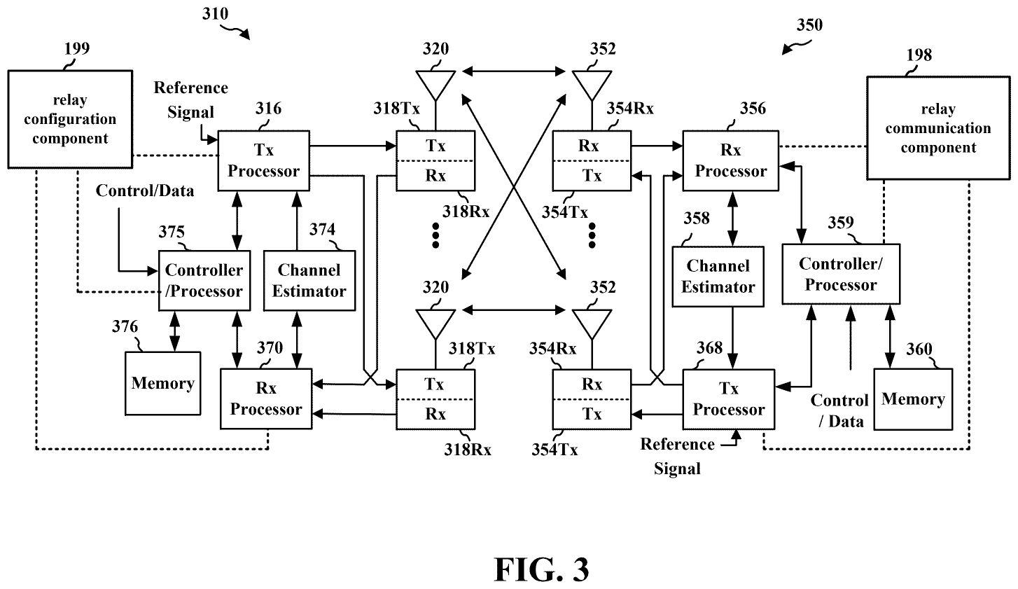

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (Tx) processor 316 and the receive (Rx) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The Tx processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (iFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (Rx) processor 356. The Tx processor 368 and the Rx processor 356 implement layer 1 functionality associated with various signal processing functions. The Rx processor 356 may perform spatial processing on the information to recover any spatial streams destined for the UE 350. If multiple spatial streams are destined for the UE 350, they may be combined by the Rx processor 356 into a single OFDM symbol stream. The Rx processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the Tx processor 368 to select the appropriate coding and modulation schemes, and to facilitate spatial processing. The spatial streams generated by the Tx processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a Rx processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the Tx processor 368, the Rx processor 356, and the controller/processor 359 may be configured to perform aspects in connection with the relay communication component 198 of FIG. 1.

At least one of the Tx processor 316, the Rx processor 370, and the controller/processor 375 may be configured to perform aspects in connection with the relay configuration component 199 of FIG. 1.

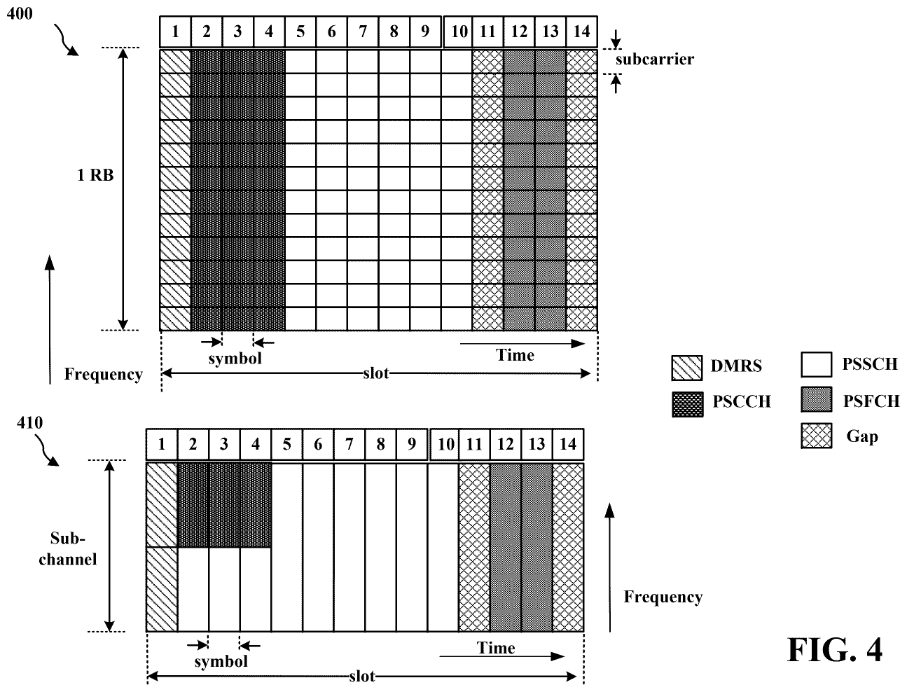

FIG. 4 includes diagram 400 and diagram 410 illustrating example aspects of slot structures that may be used for sidelink communication (e.g., between UEs 104, RSU 107, etc.). The slot structure may be within a 5G/NR frame structure in some examples. In other examples, the slot structure may be within an LTE frame structure. Although the following description may be focused on 5G NR, the concepts described herein may be applicable to other similar areas, such as LTE, LTE-A, CDMA, GSM, and other wireless technologies. The example slot structure in FIG. 4 is merely one example, and other sidelink communication may have a different frame structure and/or different channels for sidelink communication. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. Diagram 400 illustrates a single resource block of a single slot transmission, e.g., which may correspond to a 0.5 ms transmission time interval (TTI). A physical sidelink control channel may be configured to occupy multiple physical resource blocks (PRBs), e.g., 10, 12, 15, 20, or 25 PRBs. The PSCCH may be limited to a single sub-channel. A PSCCH duration may be configured to be 2 symbols or 3 symbols, for example. A sub-channel may include 10, 15, 20, 25, 50, 75, or 100 PRBs, for example. The resources for a sidelink transmission may be selected from a resource pool including one or more subchannels. As a non-limiting example, the resource pool may include between 1-27 subchannels. A PSCCH size may be established for a resource pool, e.g., as between 10-100% of one subchannel for a duration of 2 symbols or 3 symbols. The diagram 410 in FIG. 4 illustrates an example in which the PSCCH occupies about 50% of a subchannel, as one example to illustrate the concept of PSCCH occupying a portion of a subchannel. The physical sidelink shared channel (PSCCH) occupies at least one subchannel. The PSCCH may include a first portion of sidelink control information (SCI), and the PSCCH may include a second portion of SCI in some examples.

A resource grid may be used to represent the frame structure. Each time slot may include a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 4, some of the REs may include control information in PSCCH and some REs may include demodulation RS (DMRS). At least one symbol may be used for feedback. FIG. 4 illustrates examples with two symbols for a physical sidelink feedback channel (PSFCH) with adjacent gap symbols. A symbol prior to and/or after the feedback may be used for turnaround between reception of data and transmission of the feedback. The gap enables a device to switch from operating as a transmitting device to prepare to operate as a receiving device, e.g., in the following slot. Data may be transmitted in the remaining REs, as illustrated. The data may include the data message described herein. The position of any of the data, DMRS, SCI, feedback, gap symbols, and/or LBT symbols may be different than the example illustrated in FIG. 4. Multiple slots may be aggregated together in some aspects.

Some examples of sidelink communication may include vehicle-based communication devices that can communicate from vehicle-to-vehicle (V2V), vehicle-to-infrastructure (V2I) (e.g., from the vehicle-based communication device to road infrastructure nodes such as a Road Side Unit (RSU)), vehicle-to-network (V2N) (e.g., from the vehicle-based communication device to one or more network nodes, such as a base station), vehicle-to-pedestrian (V2P), cellular vehicle-to-everything (C-V2X), and/or a combination thereof and/or with other devices, which can be collectively referred to as vehicle-to-anything (V2X) communications. Sidelink communication may be based on V2X or other D2D communication, such as Proximity Services (ProSe), etc. In addition to UEs, sidelink communication may also be transmitted and received by other transmitting and receiving devices, such as Road Side Unit (RSU) 107, etc. Sidelink communication may be exchanged using a PC5 interface, such as described in connection with the example in FIG. 4. Although the following description, including the example slot structure of FIG. 4, may provide examples for sidelink communication in connection with 5G NR, the concepts described herein may be applicable to other similar areas, such as LTE, LTE-A, CDMA, GSM, and other wireless technologies.

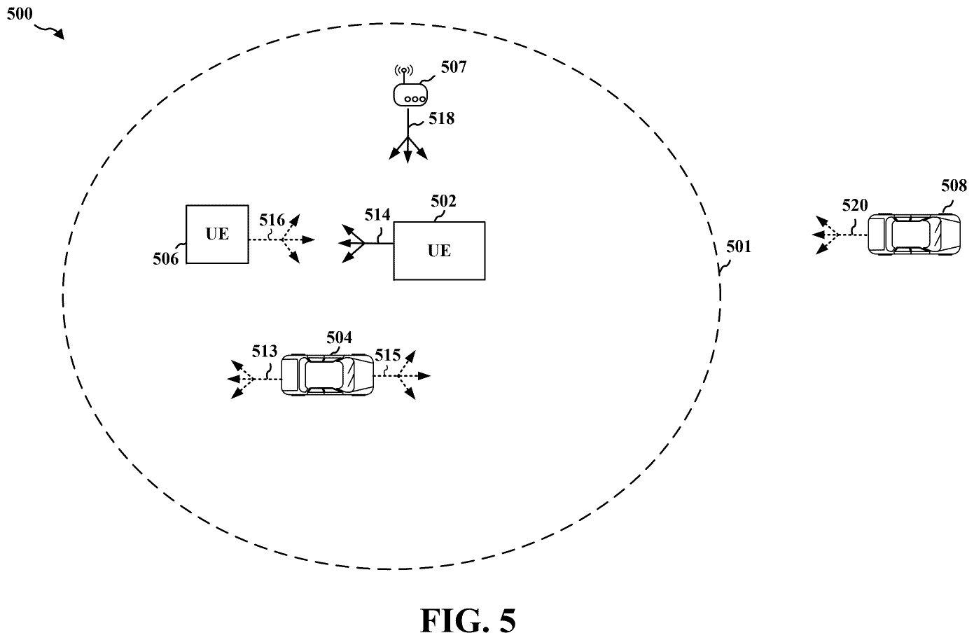

FIG. 5 illustrates an example 500 of sidelink communication between devices. The communication may be based on a slot structure including aspects described in connection with FIG. 4. For example, the UE 502 may transmit a sidelink transmission 514, e.g., including a control channel (e.g., PSCCH) and/or a corresponding data channel (e.g., PSSCH), that may be received by UEs 504, 506, 508. A control channel may include information (e.g., sidelink control information (SCI)) for decoding the data channel including reservation information, such as information about time and/or frequency resources that are reserved for the data channel transmission. For example, the SCI may indicate a number of TTIs, as well as the RBs that may be occupied by the data transmission. The SCI may be used by receiving devices to avoid interference by refraining from transmitting on the reserved resources. The UEs 502, 504, 506, 508 may each be capable of sidelink transmission in addition to sidelink reception. Thus, UEs 504, 506, 508 are illustrated as transmitting sidelink transmissions 513, 515, 516, 520. The sidelink transmissions 513, 514, 515, 516, 520 may be unicast, broadcast or multicast to nearby devices. For example, UE 504 may transmit transmissions 513, 515 intended for receipt by other UEs within a range 501 of UE 504, and UE 506 may transmit transmission 516. Additionally/alternatively, RSU 507 may receive communication from and/or transmit communication transmission 518 to UEs 502, 504, 506, 508. One or more of the UEs 502, 504, 506, 508 or the RSU 507 may include a relay communication component 198 as described in connection with FIG. 1.

Sidelink communication may be based on different types or modes of resource allocation mechanisms. In another resource allocation mode (which may be referred to herein as “Mode 1”), centralized resource allocation may be provided by a network entity. For example, a network entity may determine resources for sidelink communication and may allocate resources to different wireless devices to use for sidelink transmissions. In this first mode, a wireless device may receive an allocation of sidelink resources from a base station. In a second resource allocation mode (which may be referred to herein as “Mode 2”), distributed resource allocation may be provided. In Mode 2, each wireless device may autonomously determine resources to use for sidelink transmission. In order to coordinate the selection of sidelink resources by individual wireless devices, each wireless device may use a sensing technique to monitor for resource reservations by other sidelink wireless devices and may select resources for sidelink transmissions from unreserved resources. Devices communicating based on sidelink, may determine one or more radio resources in the time and frequency domain that are used by other devices in order to select transmission resources that avoid collisions with other devices.

The sidelink transmission and/or the resource reservation may be periodic or aperiodic, where a wireless device may reserve resources for transmission in a current slot and up to two future slots (discussed below).

Thus, in the second mode (e.g., Mode 2), individual wireless devices may autonomously select resources for sidelink transmission, e.g., without a central entity such as a base station indicating the resources for the device. A first wireless device may reserve the selected resources in order to inform other wireless devices about the resources that the first wireless device intends to use for sidelink transmission(s).

In some examples, the resource selection for sidelink communication may be based on a sensing-based mechanism. For instance, before selecting a resource for a data transmission, a wireless device may first determine whether resources have been reserved by other wireless devices.

For example, as part of a sensing mechanism for resource allocation mode 2, a wireless device may determine (e.g., sense) whether a selected sidelink resource has been reserved by other wireless device(s) before selecting a sidelink resource for a data transmission. If the wireless device determines that the sidelink resource has not been reserved by other wireless devices, the wireless device may use the selected sidelink resource for transmitting the data, e.g., in a PSSCH transmission. The wireless device may estimate or determine which radio resources (e.g., sidelink resources) may be in-use and/or reserved by others by detecting and decoding sidelink control information (SCI) transmitted by other wireless devices. The wireless device may use a sensing-based resource selection algorithm to estimate or determine which radio resources are in-use and/or reserved by others. The wireless device may receive SCI from another wireless device that may include reservation information based on a resource reservation field in the SCI. The wireless device may continuously monitor for (e.g., sense) and decode SCI from peer wireless devices. The SCI may include reservation information, e.g., indicating slots and RBs that a particular wireless device has selected for a future transmission. The wireless device may exclude resources that are used and/or reserved by other wireless devices from a set of candidate resources for sidelink transmission by the wireless device, and the wireless device may select/reserve resources for a sidelink transmission from the resources that are unused and therefore form the set of candidate resources. A wireless device may continuously perform sensing for SCI with resource reservations in order to maintain a set of candidate resources from which the wireless device may select one or more resources for a sidelink transmission. Once the wireless device selects a candidate resource, the wireless device may transmit SCI indicating its own reservation of the resource for a sidelink transmission. The number of resources (e.g., sub-channels per subframe) reserved by the wireless device may depend on the size of data to be transmitted by the wireless device. Although the example is described for a wireless device receiving reservations from another wireless device, the reservations may be received from an RSU or other device communicating based on sidelink.

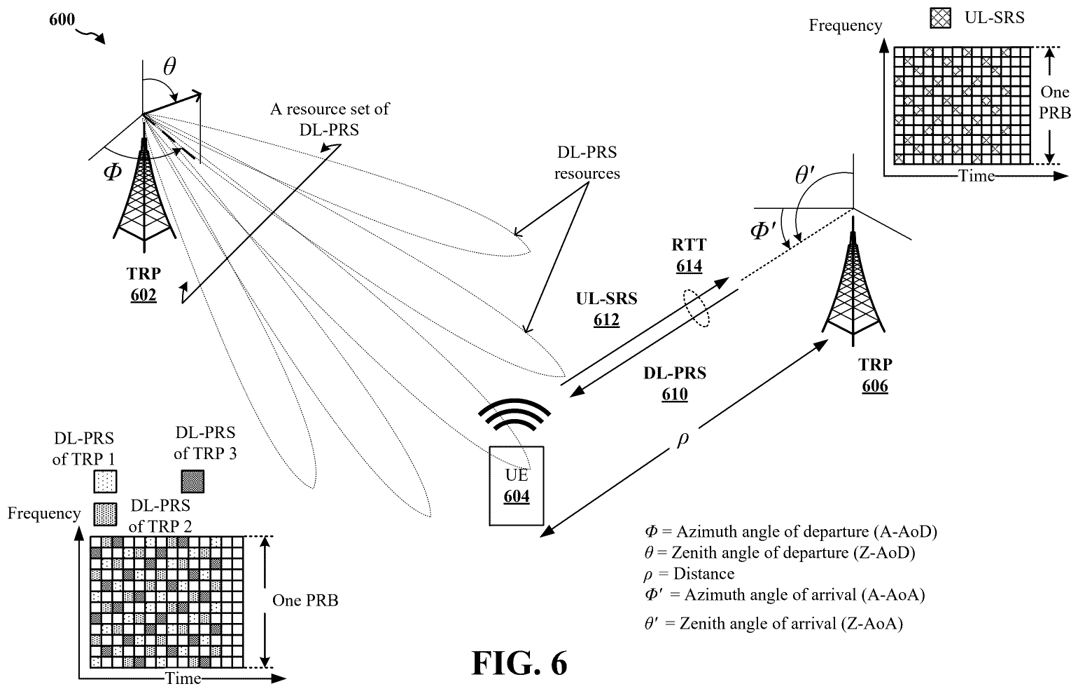

FIG. 6 is a diagram 600 illustrating an example of a UE positioning based on reference signal measurements. The UE 604 may transmit UL-SRS 612 at time TsRS_TX and receive DL positioning reference signals (PRS) (DL-PRS) 610 at time TPRS_RX. The TRP 606 may receive the UL-SRS 612 at time TSRS_RX and transmit the DL-PRS 610 at time TPRS_TX. The UE 604 may receive the DL-PRS 610 before transmitting the UL-SRS 612, or may transmit the UL-SRS 612 before receiving the DL-PRS 610. In both cases, a positioning server (e.g., location server(s) 168) or the UE 604 may determine the RTT 614 based on ∥TSRS_RX−TPRS_TX|−|TSRS_TX−TPRS_RX∥. Accordingly, multi-RTT positioning may make use of the UE Rx-Tx time difference measurements (i.e., |TSRS_TX−TPRS_RX|) and DL-PRS reference signal received power (RSRP) (DL-PRS-RSRP) of downlink signals received from multiple TRPs 602, 606 and measured by the UE 604, and the measured TRP Rx-Tx time difference measurements (i.e., |TSRS_RX−TPRS_TX|) and UL-SRS-RSRP at multiple TRPs 602, 606 of uplink signals transmitted from UE 604. The UE 604 measures the UE Rx-Tx time difference measurements (and optionally DL-PRS-RSRP of the received signals) using assistance data received from the positioning server, and the TRPs 602, 606 measure the gNB Rx-Tx time difference measurements (and optionally UL-SRS-RSRP of the received signals) using assistance data received from the positioning server. The measurements may be used at the positioning server or the UE 604 to determine the RTT, which is used to estimate the location of the UE 604. Other methods are possible for determining the RTT, such as, for example, using DL-TDOA and/or UL-TDOA measurements.

DL-AoD positioning may make use of the measured DL-PRS-RSRP of downlink signals received from multiple TRPs 602, 606 at the UE 604. The UE 604 measures the DL-PRS-RSRP of the received signals using assistance data received from the positioning server, and the resulting measurements are used along with the azimuth angle of departure (A-AoD), the zenith angle of departure (Z-AoD), and other configuration information to locate the UE 604 in relation to the neighboring TRPs 602, 606.

DL-TDOA positioning may make use of the DL reference signal time difference (RSTD) (and optionally DL-PRS-RSRP) of downlink signals received from multiple TRPs 602, 606 at the UE 604. The UE 604 measures the DL RSTD (and optionally DL-PRS-RSRP) of the received signals using assistance data received from the positioning server, and the resulting measurements are used along with other configuration information to locate the UE 604 in relation to the neighboring TRPs 602, 606.

UL-TDOA positioning may make use of the UL relative time of arrival (RTOA) (and optionally UL-SRS-RSRP) at multiple TRPs 602, 606 of uplink signals transmitted from UE 604. The TRPs 602, 606 measure the UL-RTOA (and optionally UL-SRS-RSRP) of the received signals using assistance data received from the positioning server, and the resulting measurements are used along with other configuration information to estimate the location of the UE 604.

UL-AoA positioning may make use of the measured azimuth angle of arrival (A-AoA) and zenith angle of arrival (Z-AoA) at multiple TRPs 602, 606 of uplink signals transmitted from the UE 604. The TRPs 602, 606 measure the A-AoA and the Z-AoA of the received signals using assistance data received from the positioning server, and the resulting measurements are used along with other configuration information to estimate the location of the UE 604.

Additional positioning methods may be used for estimating the location of the UE 604, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

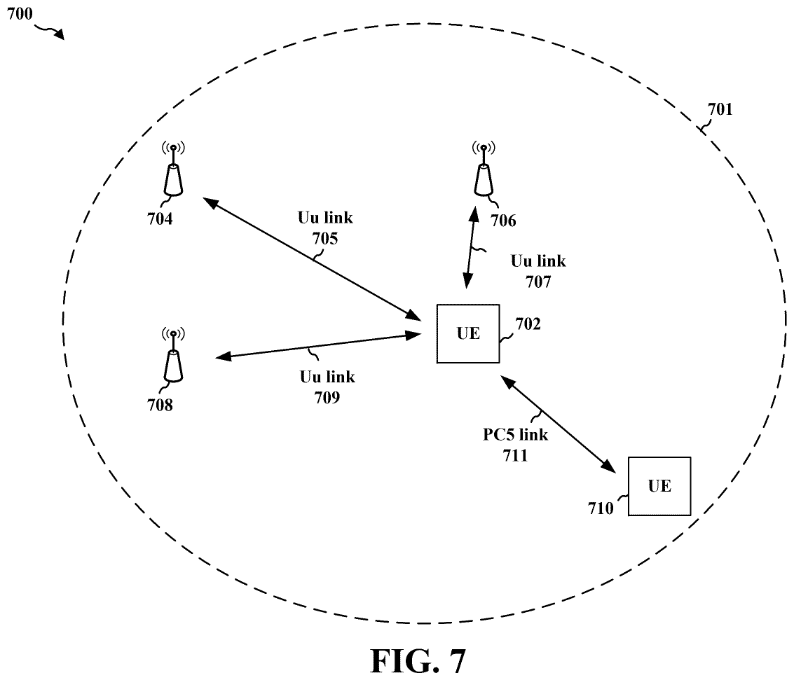

FIG. 7 is a diagram 700 illustrating an example of a remote UE 710 configured to perform a positioning session through a relay UE 702. Each of the relay UE 702 and the remote UE 710 may be a UE similar to the UE 104 in FIG. 1. Each of the network entity 704, network entity 706, and network entity 708 may be a base station similar to the base station 102 in FIG. 1.

Each of the relay UE 702, the network entity 704, the network entity 706, the network entity 708, and the remote UE 710 may be located within a common zone or range 701 that allow the wireless devices to communicate with one another via wireless links. In one aspect, the relay UE 702 may communicate with network entities 704, 706, and 708 within a zone or a range 501. The relay UE 702 may communicate with network entities 704, 706, and 708 using any suitable RF access link, such as a UE-to-universal mobile telecommunications system (UMTS) terrestrial radio access network (UE-UTRAN or Uu) link. The relay UE 702 may communicate with network entity 704 using Uu link 705, may communicate with network entity 706 using Uu link 707, and may communicate with network entity 708 using Uu link 709. The relay UE 702 may use the Uu links 705, 707, and 709 to perform positioning by calculating round trip time (RTT) and/or time difference of arrival (TDOA) measurements. In one aspect, an LMF may transmit a PRS from the network entity 704 to the relay UE 702 using the Uu link 705 to perform a positioning measurement for a period of time, such as an RTT or a TDOA. In one aspect, an LMF may transmit a PRS from the network entity 706 to the relay UE 702 using the Uu link 707 to perform a positioning measurement for a period of time, such as an RTT or a TDOA. In one aspect, an LMF may transmit a PRS from the network entity 708 to the relay UE 702 using the Uu link 709 to perform a positioning measurement for a period of time, such as an RTT or a TDOA. Each of the network entities 704, 706, and 708 may act as location anchors for the relay UE 702 to determine its location using one or more positioning measurements. The LMF or the relay UE 702 may use the positioning measurements to determine a location of the relay UE 702, which may then be used to perform positioning for remote UEs that may be configured to communicate with the relay UE 702 via sidelink, such as the remote UE 710.

The relay UE 702 may communicate with the remote UE 710 using any suitable RF access link, such as the PC5 link 711, also referred to as a sidelink. The relay UE 702 may have a known location, for example a location known to the relay UE 702 or known by a network entity, such as a location management function (LMF). The known location of the relay UE 702 may provide an anchor to the remote UE 710 to provide sidelink positioning assistance to the remote UE 710. The relay UE 702 or the remote UE 710 may calculate a positioning measurement, such as a sidelink RTT, using the PC5 link 711. For example, the relay UE 702 may transmit a PRS to the remote UE 710 using the PC5 link 711, the remote UE 710 may perform a positioning measurement on the PRS, such as an RTT, and may return a result of the measurement report to the relay UE 702.

In one aspect, the remote UE 710 may communicate with one or more of the network entities 704, 706, and 708 within a zone or a range 501. The remote UE 710 may communicate with network entities 704, 706, and 708 using any suitable RF access link, such as Uu links similar to Uu links 705, 707, and 709. The remote UE 710 may use such Uu links to perform positioning by calculating RTT and/or TDOA measurements. In one aspect, an LMF may transmit a PRS from the network entity 704 to the remote UE 710 to perform a positioning measurement for a period of time, such as an RTT or a TDOA. In one aspect, an LMF may transmit a PRS from the network entity 706 to the remote UE 710 to perform a positioning measurement for a period of time, such as an RTT or a TDOA. In one aspect, an LMF may transmit a PRS from the network entity 708 to the remote UE 710 to perform a positioning measurement for a period of time, such as an RTT or a TDOA. Each of the network entities 704, 706, and 708 may act as location anchors for the remote UE 710 to determine its location using one or more positioning measurements. The LMF or the remote UE 710 may use the positioning measurements to determine a location of the remote UE 710.

The remote UE 710 may use the relay UE 702 as an additional anchor to improve its positioning. For example, the remote UE 710 and/or the relay UE 702 may use the PC5 link 711 to perform a positioning measurement on a PRS transmitted by the relay UE 702 to the remote UE 710, such as an RTT, to improve positioning calculations of the remote UE 710. In some aspects, the remote UE 710 may not be able to communicate with some of the network entities 704, 706, or 708, for example because of blockage or other poor network conditions, improving the usefulness of utilizing the relay UE 702 to perform positioning measurements using the PC5 link 711. In other words, the relay UE 702 may provide an additional positioning measurement, such as an RTT measurement, to assist the positioning of the remote UE 710. An LMF communicating with the remote UE 710 via the relay UE 702 may be configured to use the relay UE 702 as an anchor UE that transmits a sidelink PRS (SL-PRS) that may be transmitted by the relay UE 702 to the remote UE 710. The remote UE 710 may be configured to perform a measurement report on the SL-PRS from the relay UE 702.

A UE, such as the relay UE 702 and/or the remote UE 710, may be configured to discover which positioning peer (Pos-Peer) UEs may be in the vicinity of a target UE using any suitable means. In a first discovery mode (which may be referred to herein as “Mode A”), a Pos-Peer UE may announce its presence to one or more target UEs by transmitting (e.g., via a sidelink broadcast, unicast, or multicast) a sidelink positioning (SL-Pos) discovery message having a positioning flag. A UE receiving the SL-Pos discovery message may transmit a discovery response back to the Pos-Peer UE to establish a sidelink positioning setup. In a second discovery mode (which may be referred to herein as “Mode B”), a target UE configured to discover Pos-Peer UEs by initiating (e.g., via a sidelink broadcast, unicast, or multicast) an SL-POS solicitation message with one or more fields related to positioning. A Pos-Peer UE receiving such a solicitation may provide a solicitation response to the target UE to establish a sidelink positioning setup. Both a SL-Pos discovery message and/or a SL-Pos solicitation message may be split into two or more parts to provide a more power-efficient aspect. A handshake may be performed between a target UE and a Pos-Peer UE in response to a Pos-Peer discovery message, a Pos-Peer discovery response, a Pos-Peer solicitation message, or a Pos-Peer solicitation response. A target UE may be configured to rank one or more potential Pos-Peer UEs based on at least one of an anchor location's quality criterion, a channel quality criterion, a response time criterion, or a mobility state criterion.

The relay UE 702 may be configured to handle end-to-end (E2E) QoS configuration for the remote UE 710. In one aspect, the relay UE 702 may be configured with a Uu to PC5 QoS mapping. For example, a network entity, such as the network entity 704, may provide the relay UE 702 with at least one of a 5G QoS indicator (5QI) mapping table, a PC5 5QI (PQI) mapping table or a PQI packet data budget (PDB) adjustment factor. Such configurations may be provided by a network entity via RRC configuration. The relay UE 702 may be configured to map a Uu QoS configured by a network entity, such as the network entity 704, to a PC5 QoS using such a mapping table. The remote UE 710 may be configured to transmit a PC5 QoS context to the relay UE 702. Such a PC5 QoS context may indicate E2E QoS conditions to the relay UE 702. In response to receiving a PC5 QoS context from the remote UE 710, the relay UE 702 may use a UE initiated protocol data unit (PDU) session modification to transmit one or more of the QoS conditions to the network entity. In one aspect, the relay UE 702 may be configured to support reflective QoS over a Uu link, such as the Uu link 705.

For example, the network entity 704 may configure a QoS of a Uu PDB to be 75 ms. The relay UE 702 may map the QoS of a Uu PDB of 75 ms to a QoS of a PC5 PDB of 25 ms. The relay UE 702 may then add these two results to configure a QoS of an E2E PDB of 100 ms. In other words, the relay UE 702 may be configured to handle E2E QoS configurations for the remote UE 710 by increasing a QoS latency of configured PDBs using one or more mapping tables that map a QoS of a Uu PDB to a QoS of a PC5 PDB.

While the relay UE 702 may be able to use mapping tables to increase a QoS latency, such mapping tables may not be able to be used for positioning of the remote UE 710 with respect to the relay UE 702 as the RTT values change as the relay UE 702 changes its position and/or as the remote UE 710 changes its position. A network entity, such as the network entity 704 may be configured to provide response time QoS parameter for a Uu link, such as the Uu link 705, and for a sidelink, such as the PC5 link 711.

In one aspect, a relay UE may be configured to receive an indication of one or more of at least one first QoS parameter for a first wireless link or at least one second QoS parameter for a second wireless link. The relay UE may receive the indication from a network entity. The first wireless link may be associated with the relay UE and the network entity. The second wireless link may be associated with the relay UE and at least one remote UE. The at least one first QoS parameter and the at least one second QoS parameter may be associated with a time period. The relay UE may be configured to transmit a report of at least one positioning measurement within the time period based on one or more of the at least one first QoS parameter or the at least one second QoS parameter. The report may be transmitted to the network entity.

In one aspect, a network entity may be configured to transmit an indication of one or more of at least one first QoS parameter for a first wireless link or at least one second QoS parameter for a second wireless link. The indication may be output to a relay UE. The first wireless link may be associated with the relay UE and the network entity. The second wireless link may be associated with the relay UE and at least one remote UE. The at least one first QoS parameter and the at least one second QoS parameter may be associated with a time period. The network entity may be configured to obtain a report of at least one positioning measurement within the time period based on one or more of the at least one first QoS parameter or the at least one second QoS parameter. The report may be obtained from the relay UE.

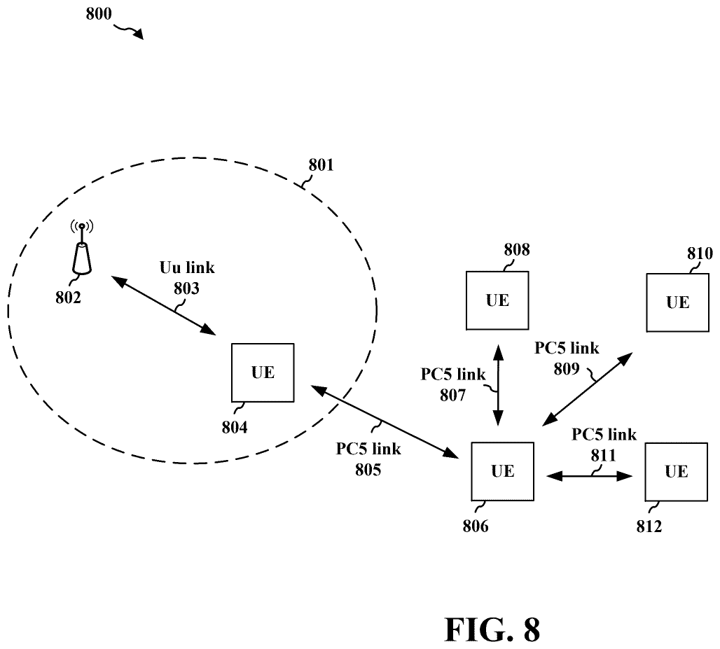

FIG. 8 is a diagram 800 illustrating an example of a remote UE 806 configured to perform a positioning session with a network entity 802 via a relay UE 804. One or more of the remote UEs 808, 810, and 812 may act as additional anchors for the remote UE 806. Each of the relay UE 804, remote UE 806, remote UE 808, remote UE 810, and remote UE 812 may be a UE similar to the UE 104 in FIG. 1. The network entity 802 may be a base station similar to the base station 102 in FIG. 1. The network entity 802 may include an LMF.

Each of the network entity 802 and the relay UE 804 may be located in a common zone or range 801 that allow the wireless devices to communicate with one another via wireless links. The relay UE 804 may communicate with the network entity 802 via Uu link 803. The relay UE 804 may use the Uu link 803 to perform positioning by calculating RTT and/or TDOA measurements. The remote UEs 806, 808, 810, and 812 may be outside the zone or range 801, preventing the network entity 802 from communicating with any of the remote UEs 806, 808, 810, and 812 via a Uu link.

The relay UE 804 may communicate with the remote UE 806 via a PC5 link 805. The remote UE 806 may communicate with the remote UE 808 via a PC5 link 807. The remote UE 806 may communicate with the remote UE 810 via a PC5 link 809. The remote UE 806 may communicate with the remote UE 812 via a PC5 link 811. A response time condition for the remote UE 806 may be a function of (1) the Uu link 803 between the UE 804 and the network entity 802, which may include a backhaul network to an LMF, (2) the PC5 link 805 between the relay UE 804 and the remote UE 806, and (3) the PC5 links 807, 809, and 811 between the remote UE 806 and the remote UEs 808, 810, and 812, respectively.

In one aspect, the network entity 802 may be configured to provide a QoS response time for the Uu link 803 and/or the PC5 link 805. The response time for the Uu link 803 may be calculated as a response time between the relay UE 804 and a TRP of the network entity 802. The response time for the Uu link 803 may be calculated as a response time between the relay UE 804 and an LMF of the network entity 802. The network entity 802 may provide one or more QoS parameters for the Uu link 803 and/or the PC5 link 805. In one aspect, one or more QoS parameters may be provided by an LMF of the network entity 802. The LMF of the network entity 802 may provide the one or more QoS parameters in an assistant data (AD) to the relay UE 804. In one aspect, the QoS parameters may be provided in an RRC configuration or as a part of a PRS.

In one aspect, the network entity 802 may provide an E2E response time (e.g., a sum of the response time for the Uu link 803 and the response time for the PC5 link 805) to the relay UE 804. The network entity 802 may provide a response time for the PC5 link 805 to the relay UE 804. The relay UE 804 may calculate the response time for the Uu link 803 by subtracting the response time for the PC5 link 805 from the E2E response time.

In one aspect, the network entity 802 may provide an E2E response time (e.g., a sum of the response time for the Uu link 803 and the response time for the PC5 link 805) to the relay UE 804. The network entity 802 may provide a response time for the Uu link 803 to the relay UE 804. The relay UE 804 may calculate the response time for the PC5 link 805 by subtracting the response time for the Uu link 803 from the E2E response time.

In one aspect, the network entity 802 may provide a response time for the Uu link 803 to the relay UE 804. The network entity 802 may provide a response time for the PC5 link 805 to the relay UE 804. The relay UE 804 may calculate an E2E response time by summing the response time for the Uu link 803 and the response time for the PC5 link 805.

In one aspect, the network entity 802 may provide an aggregated response time to the relay UE 804. The aggregated response time may be a sum of a sidelink measurement period, a response time for the PC5 link 805, and a response time for the Uu link 803. The network entity 802 may assume an upper bound of the response time for the PC5 link 805 and the response time for the Uu link 803. Such upper bounds may be predetermined by a configuration, such as an RRC configuration or as assistance data (AD). The response time may be selected by an index to a table provided by RRC or AD. The relay UE 804 may be configured to calculate the response time for the PC5 link 805 and the response time for the Uu link 803 based on the aggregated response time. In one aspect, the relay UE 804 may subtract an upper bound of the response time for the PC5 link 805 from the aggregated response time to determine a response time for the Uu link 803. In one aspect, the relay UE 804 may subtract an upper bound of the response time for the Uu link 803 from the aggregated response time to determine a response time for the PC5 link 805. In one aspect, the relay UE 804 may subtract an upper bound of the response time for the Uu link 803 and an upper bound of the response time for the PC5 link 805 from the aggregated response time to determine a sidelink (SL) response time.

The relay UE 804 may use at least one of the separate QoS response time for the Uu link 803, the response time for the PC5 link 805, the E2E response time, or the SL response time to perform a positioning measurement within a time period. In one aspect, the relay UE 804 may perform a positioning measurement on an RTT for the Uu link 803 based on the response time for the Uu link 803. In one aspect, the relay UE 804 may perform a positioning measurement on an RTT for the PC5 link 805 based on the response time for the PC5 link 805. In one aspect, the relay UE 804 may provide the response time for the PC5 link 805 to the remote UE 806. The remote UE 806 may perform a positioning measurement on an RTT for the PC5 link 805 based on the response time for the PC5 link 805 and may transmit a corresponding measurement report to the relay UE 804. The relay UE 804 may forward the report to the network entity 802 from the remote UE 806. In one aspect, the relay UE 804 may provide the SL response time to the remote UE 806, which may perform a positioning measurement on an RTT for at least one of the PC5 link 807, the PC5 link 809, or the PC5 link 811 based on the SL response time, and may transmit a corresponding measurement report to the relay UE 804. The relay UE 804 may forward the report to the network entity 802 from the remote UE 806. In one aspect, the relay UE 804 may provide the SL response time to the remote UE 806, which may provide the SL response time to at least one of the remote UE 808, the remote UE 810, or the remote UE 812. At least one of the remote UE 808, the remote UE 810, or the remote UE 812 may perform a positioning measurement on an RTT for at least one of the PC5 link 807, the PC5 link 809, or the PC5 link 811, respectively, based on the SL response time, and may transmit a corresponding measurement report to the remote UE 806. The remote UE 806 may forward the measurement report to the relay UE 804, which may forward the report to the network entity 802. A UE that does not independently meet the response time may indicate a failure to meet the QoS response time in a report. In some aspects, an error code or an error cause may be transmitted from the relay UE 904 or the remote UE 906 to the network entity 902 to indicate a success or a failure to meet a QoS parameter (e.g., a PC5 response time, a Uu response time, an E2E response time, or a SL response time). In one embodiment the error code or error clause may be a message that a relay UE or a remote UE is “not able to do any measurements.” In response, the network entity 902 may change a PRS configuration parameter, such as periodicity, repetition factor, bandwidth (BW), or combined symbol options based on the indication.

The relay UE 804 may aggregate measurement reports to determine whether an E2E response time has been met. In one aspect, an E2E response time between the network entity 802 and the remote UE 806 may be determined based on a sum of an RTT of the Uu link 803 and an RTT of the PC5 link 805. In one aspect, an E2E response time between the network entity 802 and the remote UE 808 may be determined based on a sum of an RTT of the Uu link 803, an RTT of the PC5 link 805, and an RTT of the PC5 link 807.

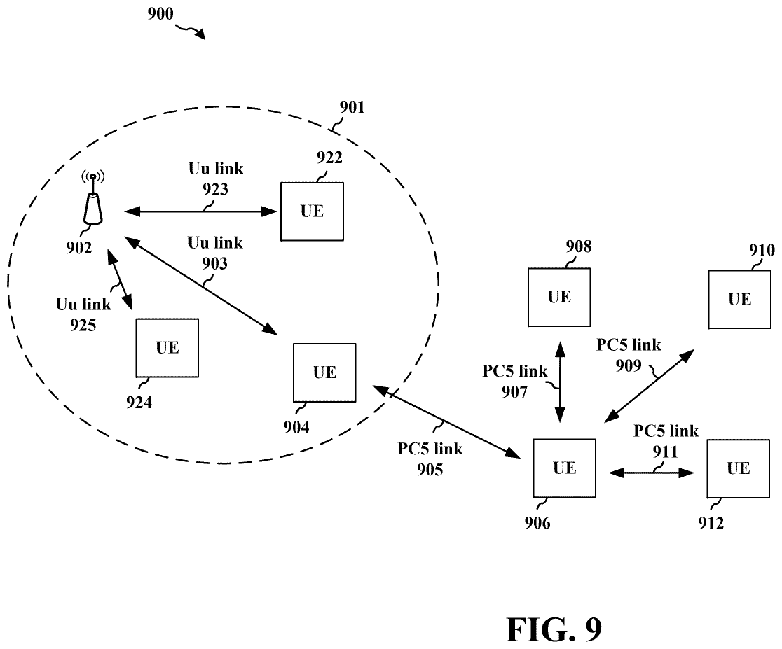

FIG. 9 is a diagram 900 illustrating an example of a remote UE 906 configured to perform a positioning session with a network entity 902 via one of the relay UEs 904, 922, and 924. One or more of the remote UEs 908, 910, and 912 may act as additional anchors for the remote UE 906. Each of the relay UE 904, relay UE 922, relay UE 924, remote UE 906, remote UE 908, remote UE 910, and remote UE 912 may be a UE similar to the UE 104 in FIG. 1. The network entity 902 may be a base station similar to the base station 102 in FIG. 1. The network entity 902 may include an LMF.

Each of the network entity 902, the relay UE 904, the relay UE 922, and the relay UE 924 may be located in a common zone or range 901 that allow the wireless devices to communicate with one another via wireless links. The relay UE 904 may communicate with the network entity 902 via Uu link 903. The relay UE 904 may use the Uu link 903 to perform positioning by calculating RTT and/or TDOA measurements. The relay UE 922 may communicate with the network entity 902 via Uu link 923. The relay UE 922 may use the Uu link 923 to perform positioning by calculating RTT and/or TDOA measurements. The relay UE 924 may communicate with the network entity 902 via Uu link 925. The relay UE 924 may use the Uu link 925 to perform positioning by calculating RTT and/or TDOA measurements. The remote UEs 906, 908, 910, and 912 may be outside the zone or range 901, preventing the network entity 902 from communicating with any of the remote UEs 906, 908, 910, and 912 via a Uu link.

The relay UE 904 may communicate with the remote UE 906 via a PC5 link 905. The remote UE 906 may communicate with the remote UE 908 via a PC5 link 907. The remote UE 906 may communicate with the remote UE 910 via a PC5 link 909. The remote UE 906 may communicate with the remote UE 912 via a PC5 link 911. A response time condition for the remote UE 906 may be a function of (1) the Uu link 903 between the relay UE 904 and the network entity 902, which may include a backhaul network to an LMF, (2) the PC5 link 905 between the relay UE 904 and the remote UE 906, and (3) the PC5 links 907, 909, and 911 between the remote UE 906 and the remote UEs 908, 910, and 912, respectively.

The network entity 902 may select a relay UE from the relay UEs 904, 922, and 924 based on a QoS of the Uu links and the PC5 links. Each of the relay UEs 904, 922, and 924 may have a different capability and channel condition relative to one another. A QoS response (e.g., an RTT or a TDOA measurement) for the Uu link 903 with the relay UE 904, for the Uu link 923 with the relay UE 922, or for the Uu link 925 with the relay UE 924 may be different than another. For example, an RTT for the Uu link 903 may be better than an RTT for the Uu link 923. Similarly, PC5 links between the relay UEs and the remote UEs may also be different from one another. One or more of the relay UEs 904, 922, and 924 may maintain a copy of a QoS parameter in a memory, and may provide this information to a remote UE or the network entity 902 for selection of a relay UE for a remote UE. A remote UE, such as the remote UE 906 may select a relay UE from the relay UEs 904, 922, and 924 to determine which one has the best response time. For example, the lowest E2E response time between the network entity 902 and the remote UE 906. In some aspects, the network entity 902 may perform an analysis of E2E response times and may provide an indication to the remote UE 906 to select a relay suggested by the network entity 902 that has a response time. In response to receiving the indication to select a relay having a better response time, the remote UE 906 may reselect the relay UE (e.g., may switch from the relay UE 904 to the relay UE 922) before performing positioning measurements. In one aspect, a remote UE may query a response time for a Uu link from a relay UE. Such a query may be useful to perform the aforementioned calculations. In one aspect, the remote UE 906 may transmit a query to the relay UE 904 via the PC5 link 905 to retrieve a response time of the Uu link 903. In one aspect, the remote UE 906 may transmit a query to the relay UE 922 to retrieve a response time of the Uu link 923. In one aspect, the remote UE 906 may transmit a query to the relay UE 924 to retrieve a response time of the Uu link 925. In some aspects, the relay UE 904 may provide a response time for a plurality of Uu links, such as a response time (e.g., RTT) of the Uu link 903, a response time of the Uu link 923, and a response time of the Uu link 925. In some aspects, the relay UE 904 may provide an E2E response time and a response time for the Uu link 903, allowing the remote UE 906 to calculate the response time for the PC5 link 905 by subtracting the response time for the Uu link 903 from the E2E response time.

In one aspect, a remote UE may provide a Uu QoS response time to a network entity. For example, the remote UE 906 may provide a Uu QoS response time as part of a position start request to an LMF of the network entity 902. The remote UE 906 may transmit a long-term evolution (LTE) positioning protocol (LPP) transmission having a response time for the Uu link 903 to the network entity 902 via the relay UE 904. A response time for the Uu link 903 may queried from the relay UE 904. The underlying response time for the Uu link 903 may be provided to an LMF of the network entity 902 as part of LPP signaling. In one aspect, the response time for the Uu link may be a part of a request AD message or a capability exchange procedure. In response to receiving the response time for the Uu link, the network entity 902 may add the response time for the Uu link to a response time to a PC5 link to determine an E2E response time. In one aspect, the network entity 902 may determine a PRS configuration based on the response time for the Uu link received from the remote UE 906. In one aspect, the network entity 902 may output a PRS configuration having a lower periodicity PRS configuration in response to the Uu link response time being equal to or greater than a threshold response time (e.g., 160 ms), or may output a PRS configuration having a higher periodicity PRS configuration in response to the Uu link response time being equal to or less than the threshold response time (e.g., 160 ms). The lower periodicity PRS configuration may have a lower periodicity than the higher periodicity PRS configuration. The PRS configuration may be output to the remote UE 906.

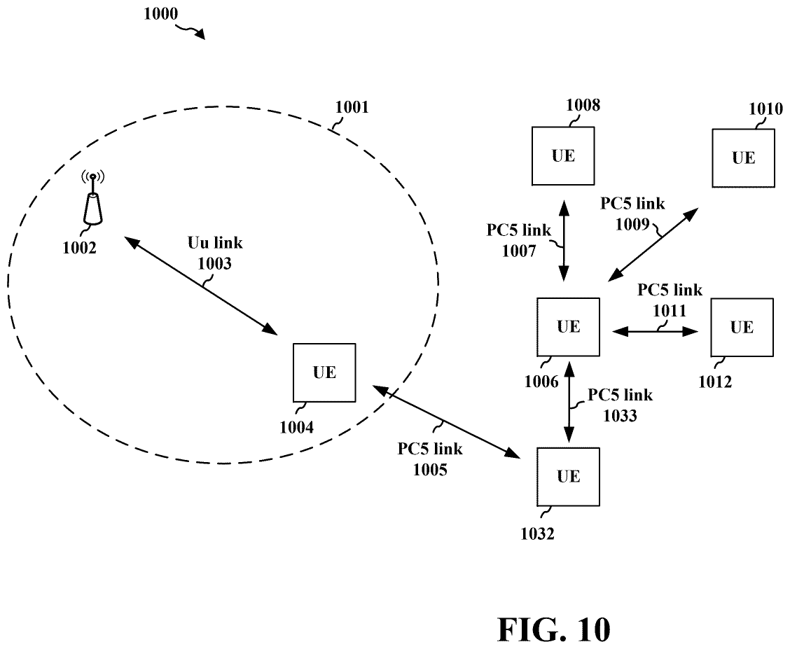

FIG. 10 is a diagram 1000 illustrating an example of a remote UE 1006 configured to perform a positioning session with a network entity 1002 via a relay UE 1032 and a relay UE 1004. One or more of the remote UEs 1008, 1010, and 1012 may act as additional anchors for the remote UE 1006. Each of the relay UE 1004, remote UE 1006, relay UE 1032, remote UE 1008, remote UE 1010, and remote UE 1012 may be a UE similar to the UE 104 in FIG. 1. The network entity 1002 may be a base station similar to the base station 102 in FIG. 1. The network entity 1002 may include an LMF.

Each of the network entity 1002 and the relay UE 1004 may be located in a common zone or range 1001 that allow the wireless devices to communicate with one another via wireless links. The relay UE 1004 may communicate with the network entity 1002 via Uu link 1003. The relay UE 1004 may use the Uu link 1003 to perform positioning by calculating RTT and/or TDOA measurements. The remote UEs 1006, 1008, 1010, and 1012 and relay UE 1032 may be outside the zone or range 1001, preventing the network entity 1002 from communicating with any of the remote UEs 1006, 1008, 1010, and 1012 via a Uu link.

The relay UE 1004 may communicate with the relay UE 1032 via a PC5 link 1005. The relay UE 1032 may communicate with the remote UE 1006 via a PC5 link 1033. The remote UE 1006 may communicate with the remote UE 1008 via a PC5 link 1007. The remote UE 1006 may communicate with the remote UE 1010 via a PC5 link 1009. The remote UE 1006 may communicate with the remote UE 1012 via a PC5 link 1011. A response time condition for the remote UE 1006 may be a function of (1) the Uu link 1003 between the UE 1004 and the network entity 1002, which may include a backhaul network to an LMF, (2) the PC5 link 1005 between the relay UE 1004 and the remote UE 1006, and (3) the PC5 links 1007, 1009, and 1011 between the remote UE 1006 and the remote UEs 1008, 1010, and 1012, respectively.

A target positioning UE may provide UE order information to the network entity 1002. A UE order may include the order of how many relays are involved in the positioning session. For example, in FIG. 10, two relay UEs (relay UE 1004 and relay UE 1032) are used, providing a UE order of two, while in FIG. 9, one relay UE (relay UE 904) is used, providing a UE order of one. Three, four, or more orders may be used in other aspects. The network entity 902 may provide a limit on a maximum order that may be used for a positioning system, such as a positioning measurement. The remote UE, such as the remote UE 1006, may be configured to select a minimum UE order for the remote UE. For example, where the remote UE 1006 has a path having a UE order of three and a path having a UE order of two, the remote UE 1006 would choose the path having the UE order of two as two is less than three.

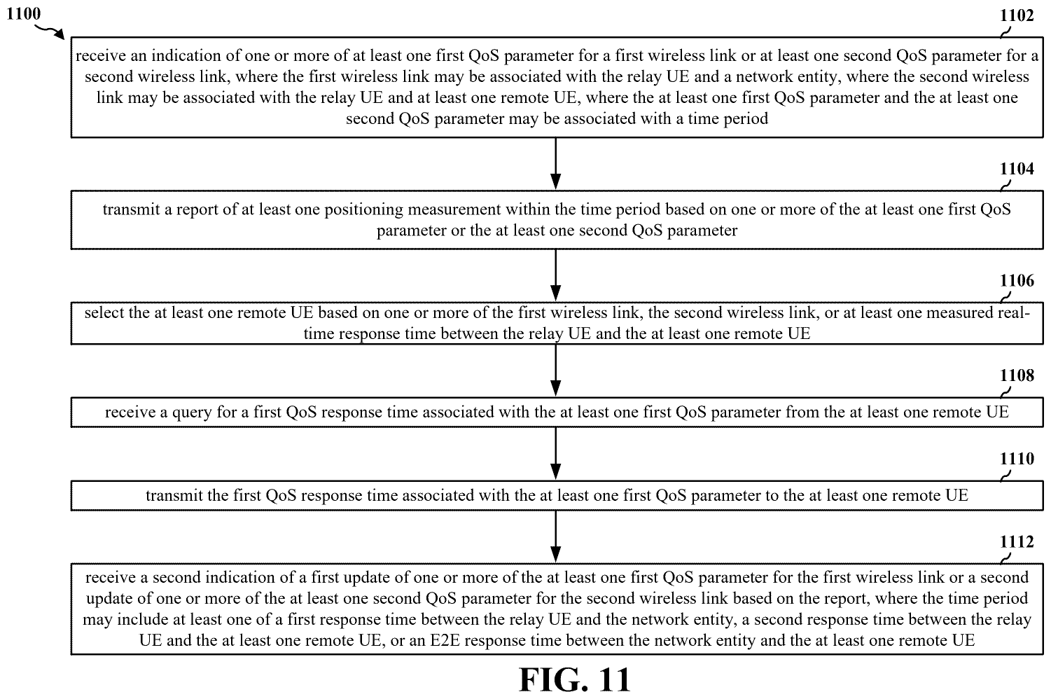

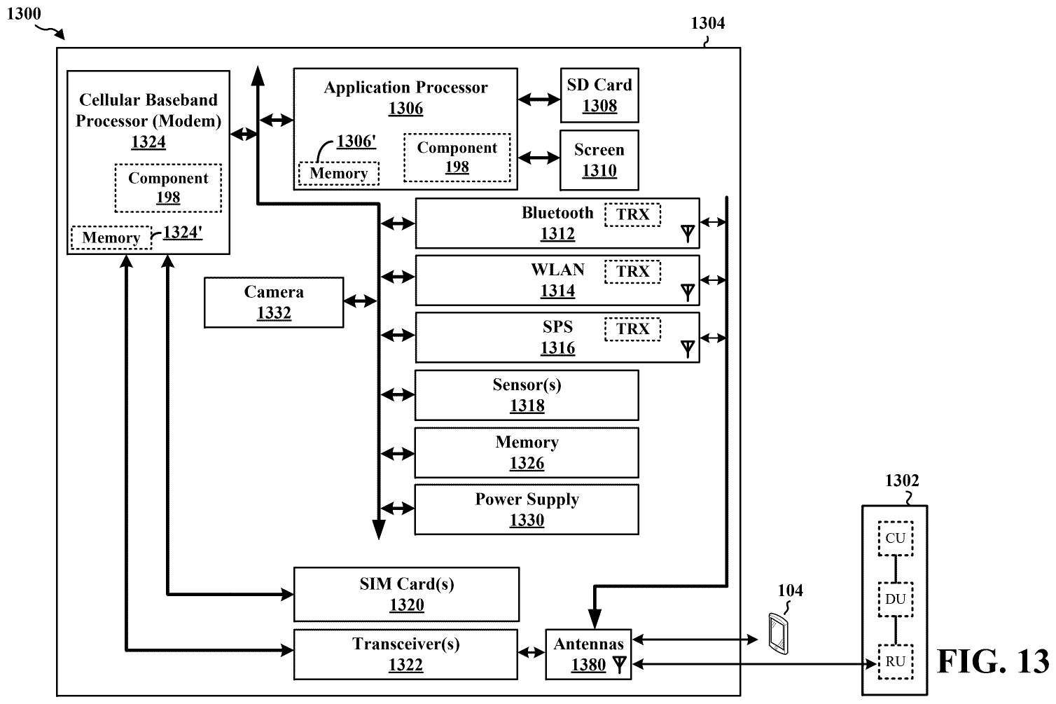

FIG. 11 is a flowchart 1100 of a method of wireless communication. The method may be performed by a relay UE (e.g., the UE 104, the UE 350, the UE 506, the UE 502, the UE 508, the UE 604; the relay UE 702, the relay UE 804, the relay UE 904, the relay UE 922, the relay UE 924, the relay UE 100, the relay UE 10324; the remote UE 710, the remote UE 806, the remote UE 808, the remote UE 810, the remote UE 812, the remote UE 906, the remote UE 908, the remote UE 910, the remote UE 912, the remote UE 1006, the remote UE 1008, the remote UE 1010, the remote UE 1012; the apparatus 1304). At 1102, the relay UE may receive an indication of one or more of at least one first QoS parameter for a first wireless link or at least one second QoS parameter for a second wireless link. The first wireless link may be associated with the relay UE and a network entity. The second wireless link may be associated with the relay UE and at least one remote UE. The at least one first QoS parameter and the at least one second QoS parameter may be associated with a time period. For example, 1102 may be performed by the component 198 in FIG. 13.

At 1104, the relay UE may transmit a report of at least one positioning measurement within the time period based on one or more of the at least one first QoS parameter or the at least one second QoS parameter. For example, 1104 may be performed by the component 198 in FIG. 13.

At 1106, the relay UE may select the at least one remote UE based on one or more of the first wireless link, the second wireless link, or at least one measured real-time response time between the relay UE and the at least one remote UE. For example, 1106 may be performed by the component 198 in FIG. 13.

At 1108, the relay UE may receive a query for a first QoS response time associated with the at least one first QoS parameter from the at least one remote UE. For example, 1108 may be performed by the component 198 in FIG. 13.

At 1110, the relay UE may transmit the first QoS response time associated with the at least one first QoS parameter to the at least one remote UE. For example, 1110 may be performed by the component 198 in FIG. 13.

At 1112, the relay UE may receive a second indication of a first update of one or more of the at least one first QoS parameter for the first wireless link or a second update of one or more of the at least one second QoS parameter for the second wireless link based on the report. The time period may include at least one of a first response time between the relay UE and the network entity, a second response time between the relay UE and the at least one remote UE, or an E2E response time between the network entity and the at least one remote UE. For example, 1112 may be performed by the component 198 in FIG. 13.

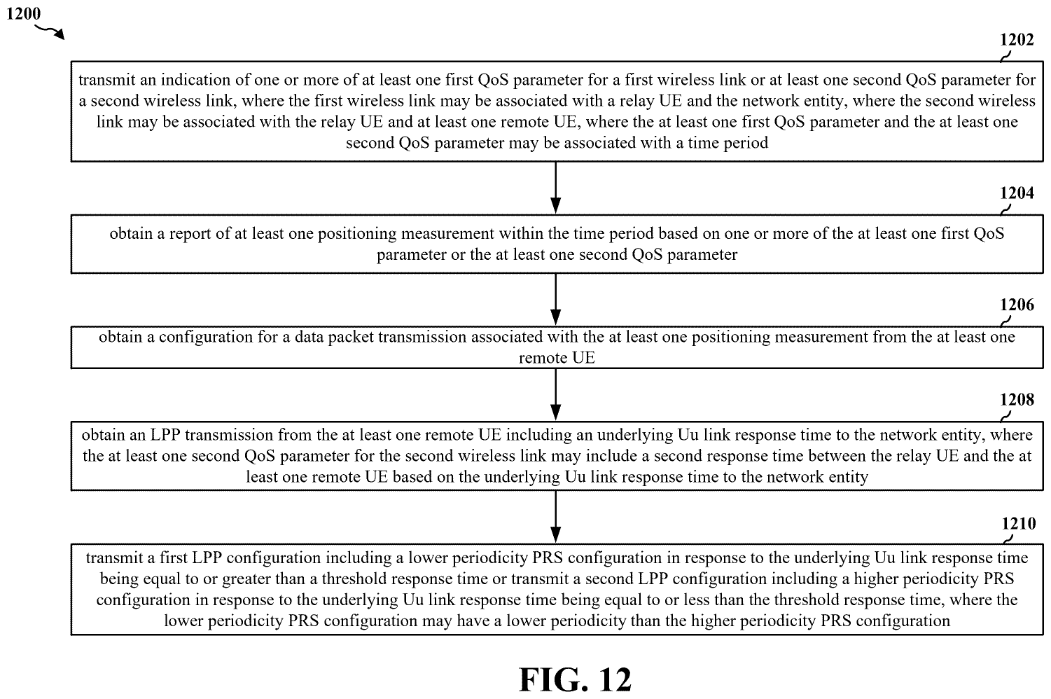

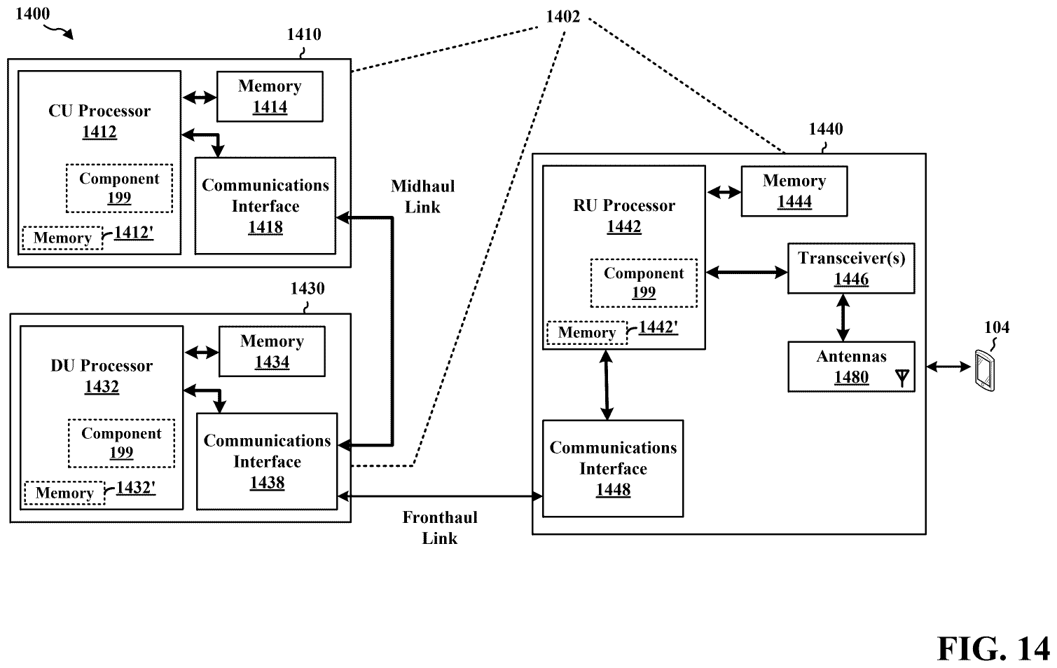

FIG. 12 is a flowchart 1200 of a method of wireless communication. The method may be performed by a network entity (e.g., the base station 102, the base station 310; the TRP 602, the TRP 606; the network entity 704, the network entity 706, the network entity 708, the network entity 802, the network entity 902, the network entity 1002, the network entity 1302, the network entity 1402, the network entity 1560). At 1202, the network entity may transmit an indication of one or more of at least one first QoS parameter for a first wireless link or at least one second QoS parameter for a second wireless link. The first wireless link may be associated with a relay UE and the network entity. The second wireless link may be associated with the relay UE and at least one remote UE. The at least one first QoS parameter and the at least one second QoS parameter may be associated with a time period. For example, 1202 may be performed by the component 199 in FIG. 14.

At 1204, the network entity may obtain a report of at least one positioning measurement within the time period based on one or more of the at least one first QoS parameter or the at least one second QoS parameter. For example, 1202 may be performed by the component 199 in FIG. 14.

At 1206, the network entity may obtain a configuration for a data packet transmission associated with the at least one positioning measurement from the at least one remote UE. For example, 1202 may be performed by the component 199 in FIG. 14.

At 1208, the network entity may obtain an LPP transmission from the at least one remote UE including a Uu link response time to the network entity. The at least one second QoS parameter for the second wireless link may include a second response time between the relay UE and the at least one remote UE based on the Uu link response time to the network entity. For example, 1202 may be performed by the component 199 in FIG. 14.

At 1210, the network entity may transmit a first PRS configuration including a lower periodicity PRS configuration in response to the Uu link response time being equal to or greater than a threshold response time or transmit a second PRS configuration including a higher periodicity PRS configuration in response to the Uu link response time being equal to or less than the threshold response time. The lower periodicity PRS configuration may have a lower periodicity than the higher periodicity PRS configuration. For example, 1202 may be performed by the component 199 in FIG. 14.

FIG. 13 is a diagram 1300 illustrating an example of a hardware implementation for an apparatus 1304. The apparatus 1304 may be a UE, a component of a UE, or may implement UE functionality. In some aspects, the apparatus 1304 may include a cellular baseband processor 1324 (also referred to as a modem) coupled to one or more transceivers 1322 (e.g., cellular RF transceiver). The cellular baseband processor 1324 may include on-chip memory 1324′. In some aspects, the apparatus 1304 may further include one or more subscriber identity modules (SIM) cards 1320 and an application processor 1306 coupled to a secure digital (SD) card 1308 and a screen 1310. The application processor 1306 may include on-chip memory 1306′. In some aspects, the apparatus 1304 may further include a Bluetooth module 1312, a WLAN module 1314, an SPS module 1316 (e.g., GNSS module), one or more sensor modules 1318 (e.g., barometric pressure sensor/altimeter; motion sensor such as inertial management unit (IMU), gyroscope, and/or accelerometer(s), magnetometer, audio and/or other technologies used for positioning), additional memory modules 1326, a power supply 1330, and/or a camera 1332. The Bluetooth module 1312, the WLAN module 1314, and the SPS module 1316 may include an on-chip transceiver (TRX) (or in some cases, just a receiver (Rx)). The Bluetooth module 1312, the WLAN module 1314, and the SPS module 1316 may include their own dedicated antennas and/or utilize the antennas 1380 for communication. The cellular baseband processor 1324 communicates through the transceiver(s) 1322 via one or more antennas 1380 with the UE 104 and/or with an RU associated with a network entity 1302. The cellular baseband processor 1324 and the application processor 1306 may each include a computer-readable medium/memory 1324′, 1306′, respectively. The additional memory modules 1326 may also be considered a computer-readable medium/memory. Each computer-readable medium/memory 1324′, 1306′, 1326 may be non-transitory. The cellular baseband processor 1324 and the application processor 1306 are each responsible for general processing, including the execution of software stored on the computer-readable medium/memory. The software, when executed by the cellular baseband processor 1324/application processor 1306, causes the cellular baseband processor 1324/application processor 1306 to perform the various functions described supra. The computer-readable medium/memory may also be used for storing data that is manipulated by the cellular baseband processor 1324/application processor 1306 when executing software. The cellular baseband processor 1324/application processor 1306 may be a component of the UE 350 and may include the memory 360 and/or at least one of the Tx processor 368, the Rx processor 356, and the controller/processor 359. In one configuration, the apparatus 1304 may be a processor chip (modem and/or application) and include just the cellular baseband processor 1324 and/or the application processor 1306, and in another configuration, the apparatus 1304 may be the entire UE (e.g., see 350 of FIG. 3) and include the additional modules of the apparatus 1304.

As discussed supra, the component 198 may be configured to receive an indication of one or more of at least one first QoS parameter for a first wireless link or at least one second QoS parameter for a second wireless link. The indication may be received from a network entity. The first wireless link may be associated with the relay UE and the network entity. The second wireless link may be associated with the relay UE and at least one remote UE. The at least one first QoS parameter and the at least one second QoS parameter may be associated with a time period. The component 198 may be configured to transmit a report of at least one positioning measurement within the time period based on one or more of the at least one first QoS parameter or the at least one second QoS parameter. The report may be transmitted to the network entity. The component 198 may be within the cellular baseband processor 1324, the application processor 1306, or both the cellular baseband processor 1324 and the application processor 1306. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1304 may include a variety of components configured for various functions. In one configuration, the apparatus 1304, and in particular the cellular baseband processor 1324 and/or the application processor 1306, includes means for receiving an indication of one or more of at least one first QoS parameter for a first wireless link or at least one second QoS parameter for a second wireless link. The apparatus 1304 may include means for transmitting a report of at least one positioning measurement within the time period based on one or more of the at least one first QoS parameter or the at least one second QoS parameter. The apparatus 1304 may include means for transmitting a request for one or more of the at least one first QoS parameter or the at least one second QoS parameter. The apparatus 1304 may include means for indicating the at least one positioning measurement based on a measured RTT being less than or equal to the time period. The apparatus 1304 may include means for indicating the at least one positioning measurement based on a measured RTT being less than or equal to a sum of a first response time between the relay UE and the network entity and a second measured response time between the relay UE and the at least one remote UE. The apparatus 1304 may include means for performing the at least one positioning measurement within the time period based on at least one of the at least one first QoS parameter or the at least one second QoS parameter. The apparatus 1304 may include means for transmitting a configuration for a data packet transmission associated with the at least one positioning measurement to the at least one remote UE. The apparatus 1304 may include means for selecting the at least one remote UE based on one or more of the first wireless link or the second wireless link. The apparatus 1304 may include means for selecting the at least one remote UE further based on at least one measured real-time response time between the relay UE and the at least one remote UE. The apparatus 1304 may include means for receiving a query for a first QoS response time associated with the at least one first QoS parameter from the at least one remote UE. The apparatus 1304 may include means for transmitting the first QoS response time associated with the at least one first QoS parameter to the at least one remote UE. The apparatus 1304 may include means for receiving the report of the at least one positioning measurement from the at least one remote UE. The apparatus 1304 may include means for transmitting the report by forwarding the report to the network entity from the at least one remote UE. The apparatus 1304 may include means for receiving a second indication of a first update of one or more of the at least one first QoS parameter for the first wireless link or a second update of one or more of the at least one second QoS parameter for the second wireless link based on the report. The apparatus 1304 may include means for receiving a maximum UE order for the report. The apparatus 1304 may include means for selecting the at least one remote UE based on the maximum UE order for the report. The means may be the component 198 of the apparatus 1304 configured to perform the functions recited by the means. As described supra, the apparatus 1304 may include the Tx processor 368, the Rx processor 356, and the controller/processor 359. As such, in one configuration, the means may be the Tx processor 368, the Rx processor 356, and/or the controller/processor 359 configured to perform the functions recited by the means.

FIG. 14 is a diagram 1400 illustrating an example of a hardware implementation for a network entity 1402. The network entity 1402 may be a BS, a component of a BS, or may implement BS functionality. The network entity 1402 may include at least one of a CU 1410, a DU 1430, or an RU 1440. For example, depending on the layer functionality handled by the component 199, the network entity 1402 may include the CU 1410; both the CU 1410 and the DU 1430; each of the CU 1410, the DU 1430, and the RU 1440; the DU 1430; both the DU 1430 and the RU 1440; or the RU 1440. The CU 1410 may include a CU processor 1412. The CU processor 1412 may include on-chip memory 1412′. In some aspects, the CU 1410 may further include additional memory modules 1414 and a communications interface 1418. The CU 1410 communicates with the DU 1430 through a midhaul link, such as an F1 interface. The DU 1430 may include a DU processor 1432. The DU processor 1432 may include on-chip memory 1432′. In some aspects, the DU 1430 may further include additional memory modules 1434 and a communications interface 1438. The DU 1430 communicates with the RU 1440 through a fronthaul link. The RU 1440 may include an RU processor 1442. The RU processor 1442 may include on-chip memory 1442′. In some aspects, the RU 1440 may further include additional memory modules 1444, one or more transceivers 1446, antennas 1480, and a communications interface 1448. The RU 1440 communicates with the UE 104. The on-chip memory 1412′, 1432′, 1442′ and the additional memory modules 1414, 1434, 1444 may each be considered a computer-readable medium/memory. Each computer-readable medium/memory may be non-transitory. Each of the processors 1412, 1432, 1442 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to transmit an indication of one or more of at least one first QoS parameter for a first wireless link or at least one second QoS parameter for a second wireless link. The indication may be transmitted to a relay UE. The first wireless link may be associated with the relay UE and the network entity. The second wireless link may be associated with the relay UE and at least one remote UE. The at least one first QoS parameter and the at least one second QoS parameter may be associated with a time period. The component 199 may be configured to obtain a report of at least one positioning measurement within the time period based on one or more of the at least one first QoS parameter or the at least one second QoS parameter. The report may be obtained from the relay UE. The component 199 may be within one or more processors of one or more of the CU 1410, DU 1430, and the RU 1440. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1402 may include a variety of components configured for various functions. In one configuration, the network entity 1402 includes means for transmitting an indication of one or more of at least one first QoS parameter for a first wireless link or at least one second QoS parameter for a second wireless link. The network entity 1402 may include means for obtaining a report of at least one positioning measurement within the time period based on one or more of the at least one first QoS parameter or the at least one second QoS parameter. The network entity 1402 may include means for receiving a request for one or more of the at least one first QoS parameter or the at least one second QoS parameter. The network entity 1402 may include means for obtaining a configuration for a data packet transmission associated with the at least one positioning measurement from the at least one remote UE. The network entity 1402 may include means for obtaining an LPP transmission from the at least one remote UE including an Uu link response time to the network entity. The network entity 1402 may include means for transmitting a first PRS configuration having a lower periodicity PRS configuration in response to the Uu link response time being equal to or greater than a threshold response time. The network entity 1402 may include means for transmitting a second PRS configuration including a higher periodicity PRS configuration in response to the Uu link response time being equal to or less than the threshold response time. The network entity 1402 may include means for transmitting a maximum UE order for the report to the relay UE based on the UE order number of relays associated with each of the at least one positioning measurement. The means may be the component 199 of the network entity 1402 configured to perform the functions recited by the means. As described supra, the network entity 1402 may include the Tx processor 316, the Rx processor 370, and the controller/processor 375. As such, in one configuration, the means may be the Tx processor 316, the Rx processor 370, and/or the controller/processor 375 configured to perform the functions recited by the means.

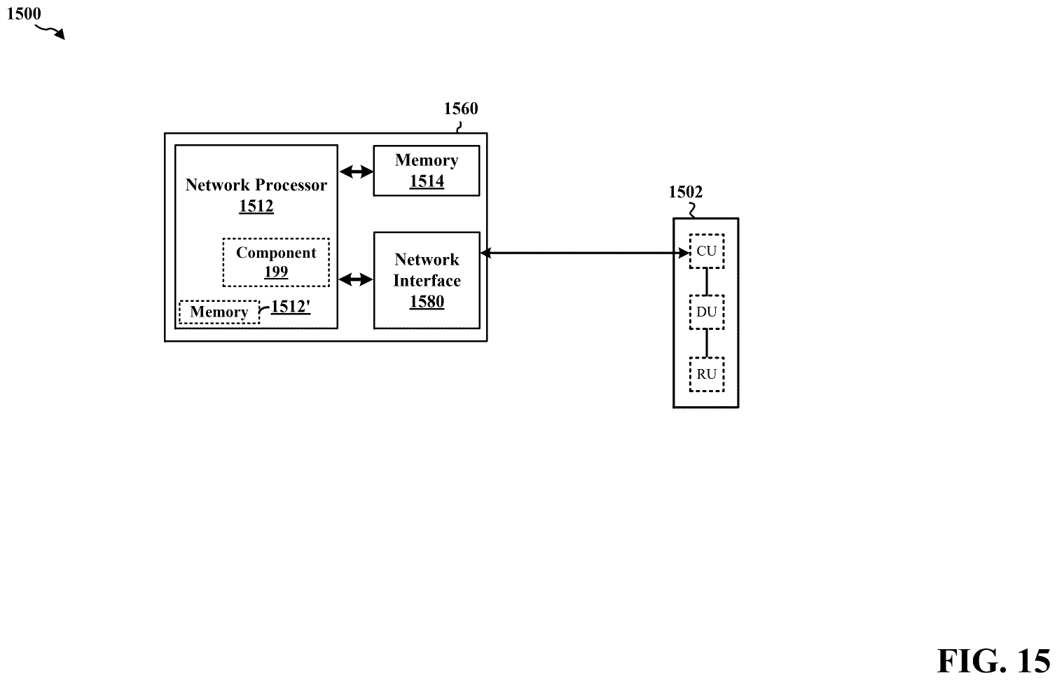

FIG. 15 is a diagram 1500 illustrating an example of a hardware implementation for a network entity 1560. In one example, the network entity 1560 may be within the core network 120. The network entity 1560 may include a network processor 1512. The network processor 1512 may include on-chip memory 1512′. In some aspects, the network entity 1560 may further include additional memory modules 1514. The network entity 1560 communicates via the network interface 1580 directly (e.g., backhaul link) or indirectly (e.g., through a RIC) with the CU 1502. The on-chip memory 1512′ and the additional memory modules 1514 may each be considered a computer-readable medium/memory. Each computer-readable medium/memory may be non-transitory. The processor 1512 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to transmit an indication of one or more of at least one first QoS parameter for a first wireless link or at least one second QoS parameter for a second wireless link. The indication may be transmitted to a relay UE. The first wireless link may be associated with the relay UE and the network entity. The second wireless link may be associated with the relay UE and at least one remote UE. The at least one first QoS parameter and the at least one second QoS parameter may be associated with a time period. The component 199 may be configured to obtain a report of at least one positioning measurement within the time period based on one or more of the at least one first QoS parameter or the at least one second QoS parameter. The report may be obtained from the relay UE. The component 199 may be within the processor 1512. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The component 199 may be a component of an LMF or may be configured to communicate with and receive instructions from an LMF. The network entity 1560 may include a variety of components configured for various functions. In one configuration, the network entity 1560 includes means for obtaining an LPP transmission from the at least one remote UE including an Uu link response time to the network entity. The network entity 1560 may include means for transmitting a first PRS configuration having a lower periodicity PRS configuration in response to the Uu link response time being equal to or greater than a threshold response time. The network entity 1560 may include means for transmitting a second PRS configuration including a higher periodicity PRS configuration in response to the Uu link response time being equal to or less than the threshold response time. The network entity 1560 may include means for transmitting a maximum UE order for the report to the relay UE based on the UE order number of relays associated with each of the at least one positioning measurement. The means may be the component 199 of the network entity 1560 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data.

The following aspects are illustrative only and may be combined with other aspects or teachings described herein, without limitation.
Aspect 1 is a method of wireless communication at a relay UE, where the method may include receiving an indication of one or more of at least one first quality of service (QOS) parameter for a first wireless link or at least one second QoS parameter for a second wireless link. The first wireless link may be associated with the relay UE and a network entity. The second wireless link may be associated with the relay UE and at least one remote UE. The at least one first QoS parameter and the at least one second QoS parameter may be associated with a time period. The method may include transmitting a report of at least one positioning measurement within the time period based on one or more of the at least one first QoS parameter or the at least one second QoS parameter.
Aspect 2 is the method of aspect 1, where the method may include transmitting a request for one or more of the at least one first QoS parameter or the at least one second QoS parameter.
Aspect 3 is the method of any of aspects 1 and 2, where the at least one first QoS parameter may include one or more of a first QoS response time or a first data packet budget. The at least one second QoS parameter may include one or more of a second QoS response time or a second data packet budget.
Aspect 4 is the method of any of aspects 1 to 3, where the first wireless link may include a UE-to-universal mobile telecommunications system (UMTS) terrestrial radio access network (UE-UTRAN or Uu) link. The second wireless link may include a sidelink.
Aspect 5 is the method of any of aspects 1 to 4, where the time period may include one or more of a first response time associated with the at least one first QoS parameter or a second response time associated with the at least one second QoS parameter.
Aspect 6 is the method of aspect 5, where the first response time may be a same time as the second response time, or the first response time may be different from the second response time.
Aspect 7 is the method of any of aspects 1 to 6, where the at least one second Qos parameter for the second wireless link may include a second response time between the relay UE and the at least one remote UE. The indication may further include an E2E response time between the network entity and the at least one remote UE. The at least one first QoS parameter for the first wireless link may be calculated as a difference between the E2E response time and the second response time.
Aspect 8 is the method of any of aspects 1 to 7, where the at least one first QoS parameter for the first wireless link may include a first response time between the relay UE and the network entity. The indication may further include an E2E response time between the network entity and the at least one remote UE. The at least one second QoS parameter for the second wireless link may be calculated as a difference between the E2E response time and the first response time.
Aspect 9 is the method of any of aspects 1 to 8, where the at least one first QoS parameter for the first wireless link may include a first response time between the relay UE and the network entity. The at least one second QoS parameter for the second wireless link may include a second response time between the relay UE and the at least one remote UE.
Aspect 10 is the method of aspect 9, where the indication may further include a sidelink measurement period for measuring a real-time response time of the at least one positioning measurement.
Aspect 11 is the method of any of aspects 1 to 10, where the method may include indicating the at least one positioning measurement based on a measured round trip time (RTT) being less than or equal to the time period.
Aspect 12 is the method of any of aspects 1 to 11, where the method may include indicating the at least one positioning measurement based on a measured RTT being less than or equal to a sum of a first response time between the relay UE and the network entity and a second measured response time between the relay UE and the at least one remote UE.
Aspect 13 is the method of any of aspects 1 to 12, where the method may include performing the at least one positioning measurement within the time period based on at least one of the at least one first QoS parameter or the at least one second QoS parameter. The report may be transmitted based on the performed at least one positioning measurement.
Aspect 14 is the method of any of aspects 1 to 13, where the method may include transmitting a configuration for a data packet transmission associated with the at least one positioning measurement to the at least one remote UE.
Aspect 15 is the method of any of aspects 1 to 14, where the method may include selecting the at least one remote UE based on one or more of the first wireless link or the second wireless link.
Aspect 16 is the method of aspect 15, where the method may include selecting the at least one remote UE further based on at least one measured real-time response time between the relay UE and the at least one remote UE.
Aspect 17 is the method of any of aspects 1 to 16, where the method may include receiving a query for a first QoS response time associated with the at least one first QoS parameter from the at least one remote UE. The method may include transmitting the first QoS response time associated with the at least one first QoS parameter to the at least one remote UE.
Aspect 18 is the method of aspect 17, where the method may include receiving the report of the at least one positioning measurement from the at least one remote UE. The time period may be based on the first QoS response time. Transmitting the report may include forwarding the report to the network entity from the at least one remote UE.
Aspect 19 is the method of any of aspects 1 to 18, where the time period may include at least one of a first response time between the relay UE and the network entity, a second response time between the relay UE and the at least one remote UE, or an E2E response time between the network entity and the at least one remote UE.
Aspect 20 is the method of aspect 19, where the method may include receiving a second indication of a first update of one or more of the at least one first QoS parameter for the first wireless link or a second update of one or more of the at least one second QoS parameter for the second wireless link based on the report.
Aspect 21 is the method of any of aspects 1 to 20, where the method may include receiving a maximum UE order for the report. The method may include selecting the at least one remote UE based on the maximum UE order for the report.
Aspect 22 is the method of any of aspects 1 to 21, where the report may further include a UE order number of relays associated with each of the at least one positioning measurement.
Aspect 23 is the method of any of aspects 1 to 22, where the report may include a second indication of a performance of the at least one positioning measurement at the relay UE or the at least one remote UE, or where the report may include a third indication of a lack of time or resources to perform the at least one positioning measurement.
Aspect 24 is a method of wireless communication at a network entity, where the method may include transmitting an indication of one or more of at least one first QoS parameter for a first wireless link or at least one second QoS parameter for a second wireless link. The first wireless link may be associated with a relay UE and the network entity. The second wireless link may be associated with the relay UE and at least one remote UE. The at least one first QoS parameter and the at least one second QoS parameter may be associated with a time period. The method may include obtaining a report of at least one positioning measurement within the time period based on one or more of the at least one first QoS parameter or the at least one second QoS parameter.
Aspect 25 is the method of aspect 24, where the method may include receiving a request for one or more of the at least one first QoS parameter or the at least one second QoS parameter.
Aspect 26 is the method of any of aspects 24 and 25, where the at least one first QoS parameter may include one or more of a first QoS response time or a first data packet budget. The at least one second QoS parameter may include one or more of a second QoS response time or a second data packet budget.
Aspect 27 is the method of any of aspects 24 to 26, where the first wireless link may include a Uu link. The second wireless link may include a sidelink.
Aspect 28 is the method of any of aspects 24 to 27, where the time period may include one or more of a first response time associated with the at least one first Qos parameter or a second response time associated with the at least one second QoS parameter.
Aspect 29 is the method of aspect 28, where the first response time may be a same time as the second response time, or the first response time may be different from the second response time.
Aspect 30 is the method of any of aspects 24 to 29, where the at least one second QoS parameter for the second wireless link may include a second response time between the relay UE and the at least one remote UE. The indication may further include an E2E response time between the network entity and the at least one remote UE.
Aspect 31 is the method of any of aspects 24 to 30, where the at least one first Qos parameter for the first wireless link may include a first response time between the relay UE and the network entity. The indication may further include an E2E response time between the network entity and the at least one remote UE.
Aspect 32 is the method of any of aspects 24 to 31, where the at least one first QoS parameter for the first wireless link may include a first response time between the relay UE and the network entity. The at least one second QoS parameter for the second wireless link may include a second response time between the relay UE and the at least one remote UE.
Aspect 33 is the method of aspect 32, where the indication may further include a sidelink measurement period for measuring a real-time response time of the at least one positioning measurement.
Aspect 34 is the method of any of aspects 24 to 33, where the report may include a second indication on a measured RTT being less than or equal to the time period.
Aspect 35 is the method of any of aspects 24 to 34, where the at least one positioning measurement may be based on a measured RTT being less than or equal to a sum of a first response time between the relay UE and the network entity and a second measured response time between the relay UE and the at least one remote UE.
Aspect 36 is the method of any of aspects 24 to 35, where the method may include obtaining a configuration for a data packet transmission associated with the at least one positioning measurement from the at least one remote UE.
Aspect 37 is the method of any of aspects 24 to 36, where the report may be obtained from the relay UE. The at least one positioning measurement may be measured from the at least one remote UE.
Aspect 38 is the method of any of aspects 24 to 37, where the time period may include at least one of a first response time between the relay UE and the network entity, a second response time between the relay UE and the at least one remote UE, or an E2E response time between the network entity and the at least one remote UE.
Aspect 39 is the method of aspect 38, where the method may include transmitting a second indication of a first update of one or more of the at least one first QoS parameter for the first wireless link or a second update of one or more of the at least one second QoS parameter for the second wireless link based on the report.
Aspect 40 is the method of any of aspects 24 to 39, where the method may include obtaining a long-term evolution (LTE) positioning protocol (LPP) transmission from the at least one remote UE including an Uu link response time to the network entity. The at least one second QoS parameter for the second wireless link may include a second response time between the relay UE and the at least one remote UE based on the Uu link response time to the network entity.
Aspect 41 is the method of aspect 40, where the method may include transmitting a first PRS configuration including a lower periodicity positioning reference signal (PRS) configuration in response to the Uu link response time being equal to or greater than a threshold response time or the method may include transmitting a second PRS configuration including a higher periodicity PRS configuration in response to the Uu link response time being equal to or less than the threshold response time. The lower periodicity PRS configuration may have a lower periodicity than the higher periodicity PRS configuration.
Aspect 42 is the method of any of aspects 24 to 41, where the report may further include a UE order number of relays associated with each of the at least one positioning measurement.
Aspect 43 is the method of aspect 42, where the method may include transmitting a maximum UE order for the report to the relay UE based on the UE order number of relays associated with each of the at least one positioning measurement.
Aspect 44 is the method of any of aspects 24 to 43, where the report may include a second indication of a performance of the at least one positioning measurement at the relay UE or the at least one remote UE, or where the report includes a third indication of a lack of time or resources to perform the at least one positioning measurement.
Aspect 45 is an apparatus for wireless communication, including: at least one memory; and at least one processor coupled to the at least one memory and, based at least in part on information stored in the at least one memory, the at least one processor, individually or in any combination, is configured to implement any of aspects 1 to 44.
Aspect 46 is the apparatus of aspect 45, further including at least one of an antenna or a transceiver coupled to the at least one processor.
Aspect 47 is an apparatus for wireless communication including means for implementing any of aspects 1 to 44.
Aspect 48 is a computer-readable medium (e.g., a non-transitory computer-readable medium) storing computer executable code, where the code when executed by at least one processor causes the at least one processor, individually or in any combination, to implement any of aspects 1 to 44.

What is claimed is:

1. An apparatus for wireless communication at a relay user equipment (UE), comprising:
a memory; and
at least one processor coupled to the memory and, based at least in part on information stored in the memory, the at least one processor is configured to:
receive an indication of one or more of at least one first quality of service (QOS) parameter for a first wireless link or at least one second QoS parameter for a second wireless link, wherein the first wireless link is associated with the relay UE and a network entity, wherein the second wireless link is associated with the relay UE and at least one remote UE, wherein the at least one first QoS parameter and the at least one second QoS parameter are associated with a time period; and
transmit a report of at least one positioning measurement within the time period based on one or more of the at least one first QoS parameter or the at least one second QoS parameter.

2. The apparatus of claim 1, further comprising a transceiver coupled to the at least one processor, wherein the at least one processor is further configured to:
transmit, via the transceiver, a request for one or more of the at least one first QoS parameter or the at least one second QoS parameter.

3. The apparatus of claim 1, wherein the at least one first QoS parameter includes one or more of a first QoS response time or a first data packet budget, and wherein the at least one second QoS parameter includes one or more of a second QoS response time or a second data packet budget.

4. The apparatus of claim 1, wherein the first wireless link comprises a UE-to-universal mobile telecommunications system (UMTS) terrestrial radio access network (UE-UTRAN/Uu) link and the second wireless link comprises a sidelink.

5. The apparatus of claim 1, wherein the time period includes one or more of a first response time associated with the at least one first QoS parameter or a second response time associated with the at least one second QoS parameter.

6. The apparatus of claim 5, wherein the first response time is a same time as the second response time, or the first response time is different from the second response time.

7. The apparatus of claim 1, wherein the at least one second QoS parameter for the second wireless link comprises a second response time between the relay UE and the at least one remote UE, wherein the indication further comprises an end-to-end (E2E) response time between the network entity and the at least one remote UE, wherein the at least one first QoS parameter for the first wireless link is calculated as a difference between the E2E response time and the second response time.

8. The apparatus of claim 1, wherein the at least one first QoS parameter for the first wireless link comprises a first response time between the relay UE and the network entity, wherein the indication further comprises an end-to-end (E2E) response time between the network entity and the at least one remote UE, wherein the at least one second QoS parameter for the second wireless link is calculated as a difference between the E2E response time and the first response time.

9. The apparatus of claim 1, wherein the at least one first QoS parameter for the first wireless link comprises a first response time between the relay UE and the network entity, wherein the at least one second QoS parameter for the second wireless link comprises a second response time between the relay UE and the at least one remote UE.

10. The apparatus of claim 9, wherein the indication further comprises a sidelink measurement period for measuring a real-time response time of the at least one positioning measurement.

11. The apparatus of claim 1, wherein the at least one processor is further configured to:
indicate the at least one positioning measurement based on a measured round trip time (RTT) being less than or equal to the time period.

12. The apparatus of claim 1, wherein the at least one processor is further configured to:
indicate the at least one positioning measurement based on a measured RTT being less than or equal to a sum of a first response time between the relay UE and the network entity and a second measured response time between the relay UE and the at least one remote UE.

13. The apparatus of claim 1, wherein the at least one processor is further configured to:
perform the at least one positioning measurement within the time period based on at least one of the at least one first QoS parameter or the at least one second QoS parameter, wherein the report is transmitted based on the performed at least one positioning measurement.

14. The apparatus of claim 1, wherein the at least one processor is further configured to:
transmit a configuration for a data packet transmission associated with the at least one positioning measurement to the at least one remote UE.

15. The apparatus of claim 1, wherein the at least one processor is further configured to:
select the at least one remote UE based on one or more of the first wireless link or the second wireless link.

16. The apparatus of claim 15, wherein the at least one processor is further configured to:
select the at least one remote UE further based on at least one measured real-time response time between the relay UE and the at least one remote UE.

17. The apparatus of claim 1, wherein the at least one processor is further configured to:
receive a query for a first QoS response time associated with the at least one first QoS parameter from the at least one remote UE; and
transmit the first QoS response time associated with the at least one first QoS parameter to the at least one remote UE.

18. The apparatus of claim 17, wherein the at least one processor is further configured to:
receive the report of the at least one positioning measurement from the at least one remote UE, wherein the time period is based on the first QoS response time, wherein the at least one processor is further configured to transmit the report by forwarding the report to the network entity from the at least one remote UE.

19. The apparatus of claim 1, wherein the time period comprises at least one of a first response time between the relay UE and the network entity, a second response time between the relay UE and the at least one remote UE, or an end-to-end (E2E) response time between the network entity and the at least one remote UE.

20. The apparatus of claim 19, wherein the at least one processor is further configured to:
receive a second indication of a first update of one or more of the at least one first QoS parameter for the first wireless link or a second update of one or more of the at least one second QoS parameter for the second wireless link based on the report.

21. The apparatus of claim 1, wherein the at least one processor is further configured to:
receive a maximum UE order for the report; and
select the at least one remote UE based on the maximum UE order for the report.

22. The apparatus of claim 1, wherein the report further comprises a UE order number of relays associated with each of the at least one positioning measurement.

23. The apparatus of claim 1, wherein the report includes a second indication of a performance of the at least one positioning measurement at the relay UE or the at least one remote UE, or wherein the report includes a third indication of a lack of time or resources to perform the at least one positioning measurement.

24. An apparatus for wireless communication at a network entity, comprising:
a memory; and
at least one processor coupled to the memory and, based at least in part on information stored in the memory, the at least one processor is configured to:
transmit an indication of one or more of at least one first quality of service (QOS) parameter for a first wireless link or at least one second QoS parameter for a second wireless link, wherein the first wireless link is associated with a relay UE and the network entity, wherein the second wireless link is associated with the relay UE and at least one remote UE, wherein the at least one first QoS parameter and the at least one second QoS parameter are associated with a time period; and
obtain a report of at least one positioning measurement within the time period based on one or more of the at least one first QoS parameter or the at least one second QoS parameter.

25. The apparatus of claim 24, further comprising a transceiver coupled to the at least one processor, wherein the at least one processor is further configured to:
obtain a configuration for a data packet transmission associated with the at least one positioning measurement from the at least one remote UE.

26. The apparatus of claim 24, wherein the at least one processor is further configured to:
obtain a long-term evolution (LTE) positioning protocol (LPP) transmission from the at least one remote UE comprising a Uu link response time to the network entity, wherein the at least one second QoS parameter for the second wireless link comprises a second response time between the relay UE and the at least one remote UE based on the Uu link response time to the network entity.

27. The apparatus of claim 26, wherein the at least one processor is further configured to:
transmit a first positioning reference signal (PRS) configuration comprising a lower periodicity PRS configuration in response to the Uu link response time being equal to or greater than a threshold response time; or
transmit a second PRS configuration comprising a higher periodicity PRS configuration in response to the Uu link response time being equal to or less than the threshold response time, wherein the lower periodicity PRS configuration has a lower periodicity than the higher periodicity PRS configuration.

28. The apparatus of claim 24, wherein the report further comprises a UE order number of relays associated with each of the at least one positioning measurement.

29. A method of wireless communication at a relay user equipment (UE), comprising:
receiving an indication of one or more of at least one first quality of service (QOS) parameter for a first wireless link or at least one second QoS parameter for a second wireless link, wherein the first wireless link is associated with the relay UE and a network entity, wherein the second wireless link is associated with the relay UE and at least one remote UE, wherein the at least one first QoS parameter and the at least one second QoS parameter are associated with a time period; and
transmitting a report of at least one positioning measurement within the time period based on one or more of the at least one first QoS parameter or the at least one second QoS parameter.

30. A method of wireless communication at a network entity, comprising:
transmitting an indication of one or more of at least one first quality of service (QoS) parameter for a first wireless link or at least one second QoS parameter for a second wireless link, wherein the first wireless link is associated with a relay UE and the network entity, wherein the second wireless link is associated with the relay UE and at least one remote UE, wherein the at least one first QoS parameter and the at least one second QoS parameter are associated with a time period; and
obtaining a report of at least one positioning measurement within the time period based on one or more of the at least one first QoS parameter or the at least one second QoS parameter.
